(19) United States
(12) Patent Application Publication
(10) Pub. No.: US 2009/0094040 A1
(43) Pub. Date: Apr. 9, 2009

(54) SYSTEMS AND METHODS FOR GENERATING AND RESPONDING TO A REQUEST FOR PROPOSAL

(76) Inventor: Curt Lewis, Granite Bay, CA (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/868,611

(22) Filed: Oct. 8, 2007

(51) Int. Cl. G06Q 99/00

(52) U.S. Cl. 705/1

(57) ABSTRACT

A method for generating a request for proposal and responding to the request for proposal is provided. The method includes generating, via a computing module stored in a computing system, a request for proposal. The method further includes providing, via the computing module, a response to the request for proposal. The method also includes receiving at least one of a first communication related to the request for proposal and a second communication related to the response by using the computing module.

### BACKGROUND OF THE INVENTION

This invention relates generally to systems and methods related to a request for proposal (RFP) and more particularly to systems and methods for generating an RFP and responding to the RFP.

The current environment for RFPs is one where a purchaser identifies a need within an organization and creates a detailed RFP to present to a potential vendor of a desired product. The RFP typically includes questions related to the vendor's capabilities, operations, financial history, service areas and more. The process of creating RFPs tends to be labor intensive. This process, which is relatively manual, is generally completed as a results of serious and tedious commitment to detail.

Once the RFP is completed, a set of rules for responding to the RFP and the RFP itself are printed, bound and sent out to the vendor. Once the RFP is received by the vendor, the vendor goes through its own due diligence process. The vendor reviews the RFP to see whether or not the vendor is qualified and whether the vendor wants to respond. If the vendor decides to respond, the RFP is sent to its proposal unit under the direction of an account manager or some other form of management. The proposal unit reviews each question within the RFP and finds appropriate responses in its response manual or has to research capabilities of the vendor. This response is then entered into a word processor to respond to any question with the RFP. Once all questions within the RFP have been addressed, the response to the RFP is prepared and sent back to the purchaser.

Some attempts have been made to computerize some aspects of the process of creating and responding to RFPs. Other systems are based on a word processing system. These semi-computerized systems lack the ease of use for creating and responding to the RFP. The purchaser and the vendor usually acquire specialized and complex software to be able to use the semi-computerized systems.

### BRIEF DESCRIPTION OF THE INVENTION

In one aspect, a method for generating a request for proposal and responding to the request for proposal is provided. The method includes generating, via a computing module stored in a computing system, a request for proposal. The method further includes providing, via the computing module, a response to the request for proposal. The method also includes receiving at least one of a first communication related to the request for proposal and a second communication related to the response by using the computing module.

In another aspect, a computing system for generating a request for proposal (RFP) and responding to the request for proposal is provided. The computing system includes an RPF memory device configured to store a request for proposal upon executing a computing module. The computing system further includes a response memory device configured to store a response to the request for proposal upon executing the computing module. The computing system also includes a processor configured to execute the computing module to output the request for proposal and communicate at least one of a first communication related to the request for proposal and a second communication related to the response.

In yet another aspect, a web-based system for generating a request for proposal and responding to the request for proposal is provided. The web-based system includes a customer computing device configured to control execution of a computing module to output a request for proposal on a web page. The web-based system further includes a supplier computing device coupled to the customer computing device via a network. The supplier computing device is configured to control execution of the computing module to output a response that is based on the request. The computing module is configured to receive at least one of a first communication related to the request for proposal and a second communication related to the response.

In still another aspect, a method for generating a request for proposal and responding to the request for proposal is described. The method includes receiving an initial request for proposal, providing an initial response to the initial request for proposal, and determining, by a processor, whether an additional request for proposal is similar to the initial request for proposal.

In another aspect, a computing system for generating a request for proposal and responding to the request for proposal is provided. The computing system includes a memory device configured to receive an initial request for proposal, a memory device configured to store an initial response to the initial request for proposal, and a processor configured to determine, whether an additional request for proposal is similar to the initial request for proposal.

### BRIEF DESCRIPTION OF THE DRAWINGS

FIG. 1 is a diagram of an embodiment of a request for proposal (RFP) system.

FIG. 2 is a block diagram of an embodiment of a client device of the system of FIG. 1.

FIG. 3 is a flowchart of an embodiment of a method for generating an RFP and responding to the RFP.

FIG. 4 is a continuation of the flowchart of FIG. 4.

FIG. 5 is an exemplary web page describing the embodiment of the method described in FIGS. 3 and 4.

FIG. 6 is another exemplary web page describing the embodiment of the method described in FIGS. 3 and 4.

FIG. 7 is yet another exemplary web page describing the embodiment of the method described in FIGS. 3 and 4.

FIG. 8 is still another exemplary web page describing the embodiment of the method described in FIGS. 3 and 4.

FIG. 9 is a flowchart of another embodiment of a method for generating an RFP and responding to the RFP.

FIG. 10 is a continuation of the flowchart of FIG. 9.

FIG. 11 is an exemplary web page describing the embodiment of the method described in FIGS. 9 and 10.

FIG. 12 is another exemplary web page describing the embodiment of the method described in FIGS. 9 and 10.

FIG. 13 is yet another exemplary web page describing the embodiment of the method described in FIGS. 9 and 10.

FIG. 14 is still another exemplary web page describing the embodiment of the method described in FIGS. 9 and 10.

FIG. 15 is another exemplary web page describing the embodiment of the method described in FIGS. 9 and 10.

FIG. 16 is a flowchart of yet another embodiment of a method for generating and responding to an RFP.

FIG. 17 is a continuation of the flowchart of FIG. 16.

FIG. 18 is a continuation of the flowchart of FIG. 17.

FIG. 19 is a continuation of the flowchart of FIG. 18.

FIG. 20 is a continuation of the flowchart of FIG. 19.

FIG. 21 is a flowchart of still another embodiment of a method for generating and responding to an RFP.

FIG. 22 is an exemplary web page describing the embodiment of the method described in FIGS. 16-20.

FIG. 23 is another exemplary web page describing the embodiment of the method described in FIGS. 16-20.

FIG. 24 is yet another exemplary web page describing the embodiment of the method described in FIGS. 16-20.

FIG. 25 is still another exemplary web page describing the embodiment of the method described in FIGS. 16-20.

FIG. 26 is another exemplary web page describing the embodiment of the method described in FIGS. 16-20.

FIG. 27 is yet another exemplary web page describing the embodiment of the method described in FIGS. 16-20.

FIG. 28 is still another exemplary web page describing the embodiment of the method described in FIGS. 16-20.

FIG. 29 is another exemplary web page describing the embodiment of the method described in FIGS. 16-20.

FIG. 30 is yet another exemplary web page describing the embodiment of the method described in FIGS. 16-20.

FIG. 31 is still another exemplary web page describing the embodiment of the method described in FIGS. 16-20.

FIG. 32 is an exemplary web page describing the embodiment of the method described in FIG. 21.

FIG. 33 is another exemplary web page describing the embodiment of the method described in FIG. 21.

FIG. 34 is a flowchart of an embodiment of a method for generating and responding to an RFP.

FIG. 35 is a flowchart of another embodiment of a method for generating and responding to an RFP.

FIG. 36 is a continuation of the flowchart of FIG. 19.

FIG. 37 is a continuation of the flowchart of FIG. 36.

FIG. 38 is an exemplary web page describing the embodiment of the method described in FIGS. 36 and 37.

FIG. 39 is another exemplary web page describing the embodiment of the method described in FIGS. 36 and 37.

FIG. 40 is yet another exemplary web page describing the embodiment of the method described in FIGS. 36 and 37

FIG. 41 is still another exemplary web page describing the embodiment of the method described in FIGS. 36 and 37

FIG. 42 is a flowchart of another embodiment of a method for generating and responding to an RFP.

### DETAILED DESCRIPTION OF THE INVENTION

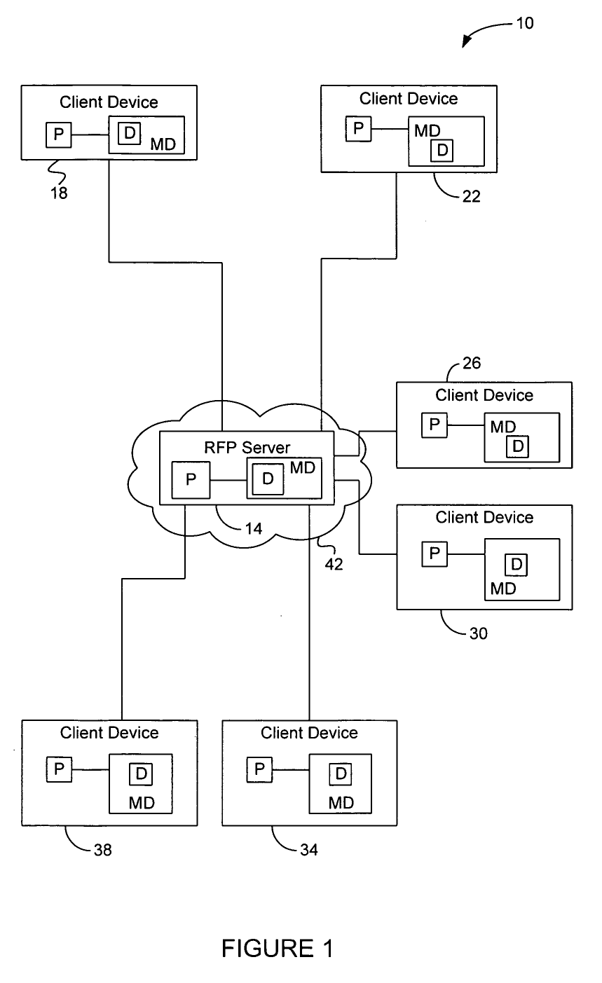

FIG. 1 is a diagram of an embodiment of a request for proposal (RFP) system 10. RFP system 10 includes an RFP server 14 and a plurality of client devices 18, 22, 26, 30, 34, and 38 connected to RFP server 14. RFP server 14 includes a processor (P) that executes a computer program, which is a computing module embodying a method for generating an RFP and responding to the RFP. As used herein, the term processor is not limited to just those integrated circuits referred to in the art as a processor, but broadly refers to a computer, a microcontroller, a microcomputer, a programmable logic controller, an application specific integrated circuit, and any other programmable circuit.

Each client device 18, 22, 26, 30, 34, and 38 is a computing device, such as a computer including a processor, and RFP server 14 is also a computing device. In one embodiment, each client device 18, 22, 26, 30, 34, and 38 is a processor. In another embodiment, RFP server 14 is a processor. Examples of the computing module include a program written in a programming language, such as C, C++, Fortran, and Assembly language. The computing module is stored within a database (D) of a memory device (MD) within RFP server 14. Examples of a memory device include a random access memory (RAM) and a read-only memory (ROM). A memory device includes a computer-readable medium, such as, a hard disc, a floppy disk, and a compact disc-read only memory (CD-ROM), and the computer-readable medium stores the computing module.

In another embodiment, the computing module is stored in a database (D) of a memory device (MD) of any of client devices 18, 22, 26, 30, 34, and 38. In yet another embodiment, portions of the computing module are stored in databases of separate memory devices. For example, a portion of the computing module is stored in the database of the memory device within client device 26 and remaining portion of the computer program is stored in the database of the memory device of RFP server 14. As another example, a portion of computing module is stored in the database of the memory device of client device 26 and the remaining portion is stored in the database of the memory device of client device 30. In yet another embodiment, a portion of computer program is stored in the database of RFP server 14 and the remaining portion is stored in the database of any of client devices 18, 22, 26, 30, 34, and 38.

In one embodiment, the computing module is stored and executed by RFP server 14 and is accessed by a user, such as a supplier or a customer, at any of client devices 18, 22, 26, 30, 34, and 38. Examples of suppliers include Sprint Nextel™ Corporation, Verizon™ Corporation, Apple Computers™ Incorporated, Intel™ Corporation, Gap™, Haggar Clothing™ Company, General Electric™ Corporation, Toyota Motor™ Company, and Masergy Communications™ Incorporated. In another embodiment, the computing module is executed by any of client devices 18, 22, 26, 30, 34, and 38. In yet another embodiment, portions of the computing module are executed by separate client devices. For example, a portion of the computing module is executed by client device 26 and the remaining portion of the computing module is executed by client device 30. In still another embodiment, a portion of computer program is executed by any of client devices 18, 22, 26, 30, 34, and 38 and the remaining portion is executed by RFP server 14.

In one embodiment client devices 18, 22, 26, 30, 34, and 38 are connected to RFP server 14 via a plurality of nodes of a network 42, such as a wide area network (WAN). In an alternative embodiment, client devices 18, 22, 26, 30, 34, and 38 are directly connected to RFP server 14 without the nodes between the client devices and RFP server 14 to form a local area network (LAN). Network 42 can be a wired network or a wireless network or a combination of the wired and wireless networks.

Client devices 18 and 22 are managed, such as owned or maintained, by a plurality of customers, such as Applied Materials™ corporation and Coherent™ Incorporated. For example, client device 18 is managed by Coherent™ Incorporated and client device 22 is managed by Applied Materials™. As another example, multiple client devices 18 and 22 are managed by the same customer. RFP server 14 is managed by either a customer, a supplier, or an administrator. Examples of administrators include DirectRFP™ Limited Liability Corporation, Avotus™ Corporation, Proposal Technologies Network™ Incorporated. Client devices 26 and 30 are managed by an administrator. Client devices 34 and 38 are managed by a supplier that supplies a product or a service to a customer.

In one embodiment, client devices 18, 22, 26, 30, 34, and 38 are computers, such as desktops or laptops, including a web browser, such that RFP server 14 is accessible to client devices using the WAN or the LAN. In another embodiment, any of client devices 18, 22, 26, 30, 34, and 38 is a device, such as, a web-based phone, personal digital assistant (PDA), or other web-based connectable equipment, capable of interconnecting to the WAN or the LAN.

Client devices 18, 22, 26, 30, 34, and 38 are interconnected to network 42 through at least one interface. Examples of interfaces interconnecting client devices 18, 22, 26, 30, 34, and 38 to the Internet include network interface cards (NICs), cable modems for providing access to data over a cable television infrastructure, and modems for transferring signals over a public switched telephone network (PSTN). In one embodiment, when client devices 18, 22, 26, 30, 34, and 38 are interconnected to the Internet, system is a world wide web-based (www-based) system in which each client device 18, 22, 26, 30, 34, and 38 executes a portion of the computing module to access one or more web pages from RFP server 14, which is a web server. A page as referred to herein is a web page accessed from RFP server 14 by a client device permitted to access the web page. It is noted that any output, such as an RFP, an RFP report, described below, and an RFP summary, also described below, is formatted into a web page accessed from RFP server 14 a client device permitted to access the web page. A web page can be displayed on an output device 108, described below, of one of client devices 18, 22, 26, 30, 34, and 38.

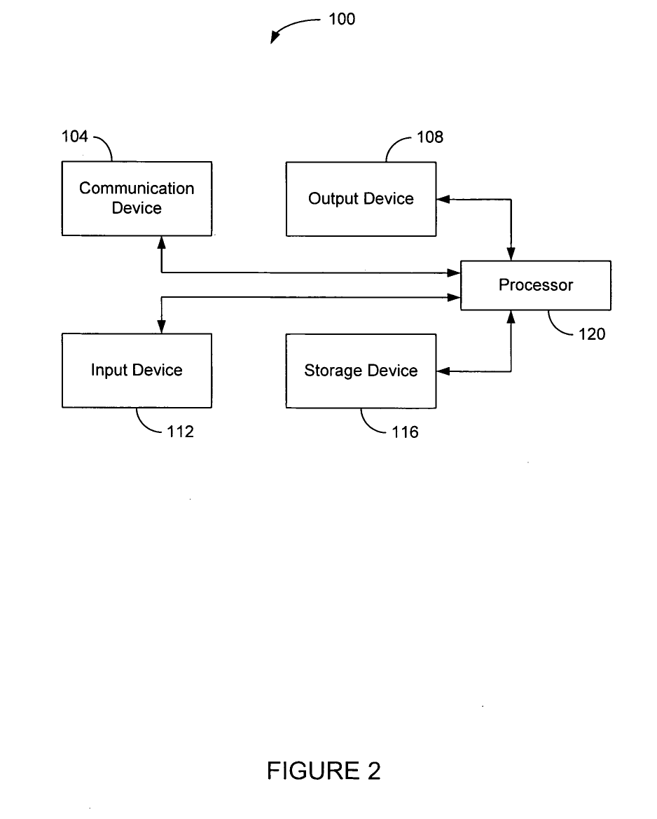

FIG. 2 is a block diagram of an embodiment of a client device 100. Client device 100 is an example of any of client devices 18, 22, 26, 30, 34, and 38. Client device 100 includes a communication device 104, an output device 108, an input device 112, a storage device 116, and a processor 120. Examples of output device 108 include a display device, such as a cathode ray tube (CRT) or a liquid crystal display (LCD). Input device 112 may be a keyboard, a stylus, a keypad, a mouse, a touch-pad, or alternatively a trackball. Client device 100 may be a personal computer (PC), such as a 286, a 386, a 486, Pentium®, Pentium® II, a Macintosh® computer, a Windows-based terminal, a network computer, a wireless device, an information appliance, a workstation, a mini-computer, a mainframe computer, a cell phone, an online gaming device, or a PDA. Communication device 104 may be a modem for transferring signals over a PSTN, a cable modem, or alternatively a NIC. Storage device 116 is an example of any of the memory device of RFP server 14, the memory device of client device 18, the memory device of client device 22, the memory device of client device 26, the memory device of client device 30, the memory device of client device 34, and the memory device of client device 38.

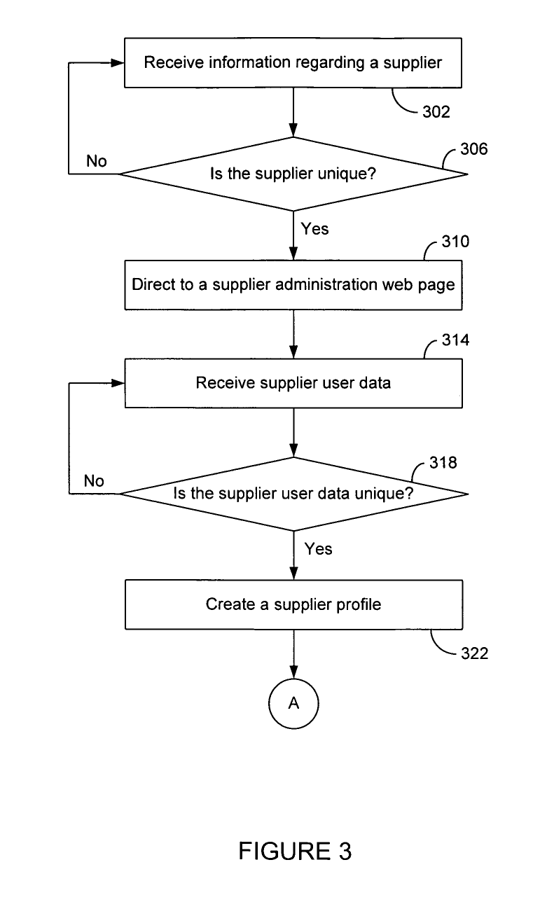

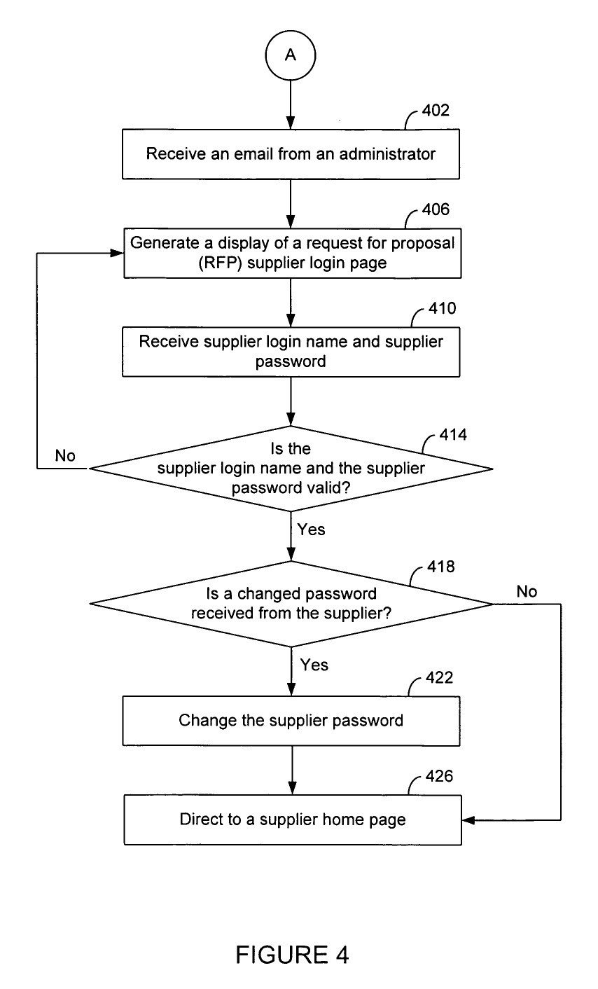

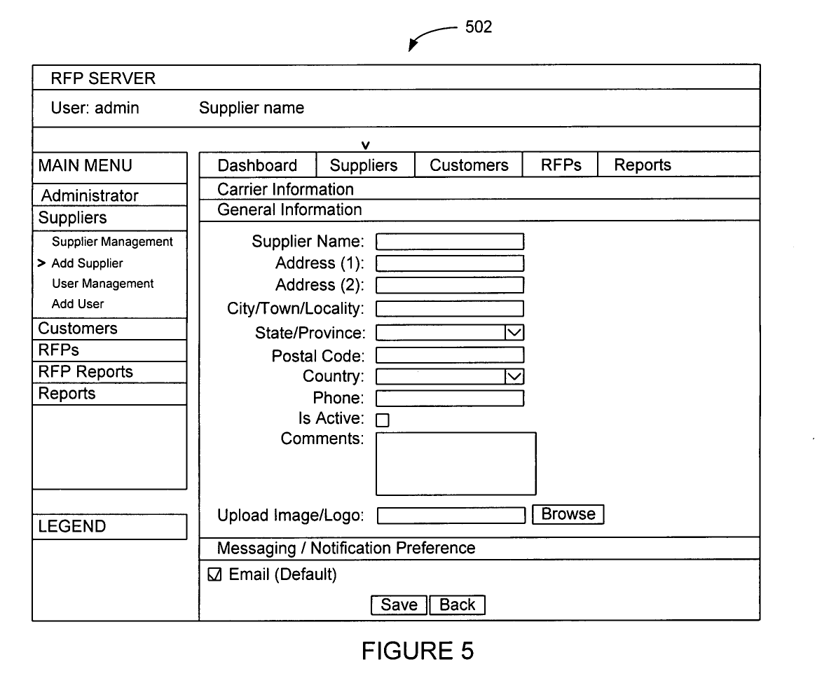

FIGS. 3 and 4 are a flowchart and FIGS. 5, 6, 7, and 8 are web pages describing an embodiment of a method for generating an RFP and responding to the RFP. The processor within client device 26 managed by an administrator receives 302 information regarding a supplier from the administrator. For example, the processor within client device 26 receives, from an administrator, a name of a supplier, a uniform resource locator (URL) of the supplier, a business address of the supplier, and any other information, such as a description of services or products offered by the supplier. As another example, the processor within client device 26 provides, an administrator, an access to a web page 502, shown in FIG. 5, from RFP server 14 and the processor receives, on the web page, a name of a supplier, a street or postal office box address of a place of business of the supplier, a city of in which the place of business is located, a state in which the place of business is located, a country in which the place of business is located, a phone of the place of business, a status as to whether the supplier is actively conducting business or not conducting business, an image, such as a trademark or a service mark, of the supplier, and other comments regarding the supplier. An administrator accesses web page 502 from RFP server 14 by providing a login identification and a password to the server. Before the processor within client device 26 receives 302 information regarding the supplier from an administrator, the administrator receives via a medium, such as electronic mail, telephone, or the Internet, the information from the supplier.

Processor within client device 26 determines 306 whether information received 302 regarding a supplier is unique. For example, the processor of client device 26 accesses a name of another supplier stored within database of RFP server 14 and determines whether the name matches a name of supplier received 302 by the processor. As another example, the processor of client device 26 accesses a URL of another supplier stored within database of RFP server 14 and determines whether the URL matches a URL of supplier received 302 by the processor.

Upon determining 306 that the information regarding a supplier received by processor of client device 26 is not unique, the processor of client device 26 managed by an administrator continues to provide an option to the administrator to change the information and receives 302 the changed information. The processor of client device 26 continues to prompt an administrator to continue to provide changed information regarding a supplier until the processor determines that information regarding a supplier is unique.

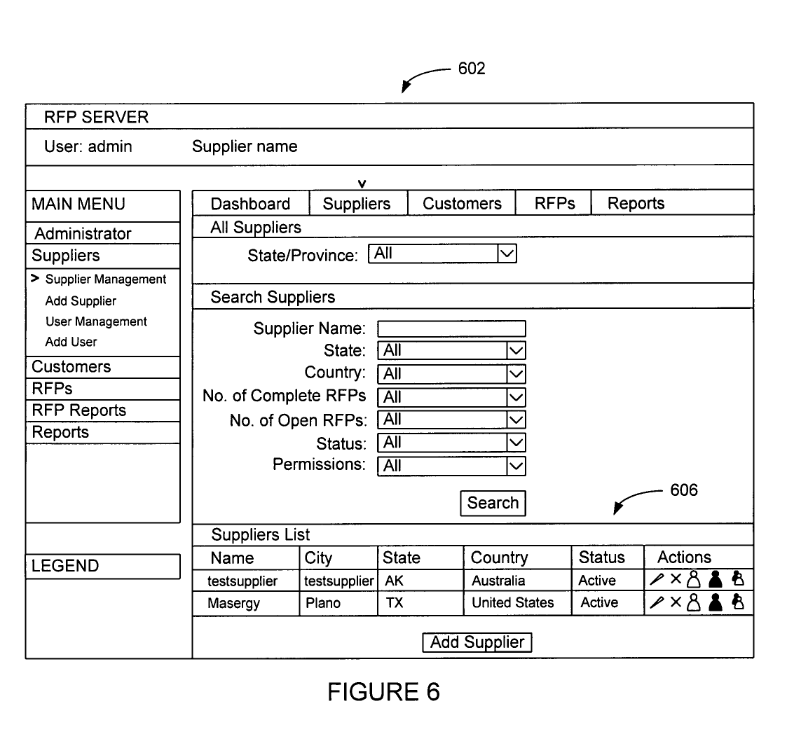

Upon determining 306 that information received 302 regarding a supplier is unique, the processor of client device 26 directs 310 an administrator to a supplier administration web page stored within RFP server 14 and the supplier administration web page is displayed on the client device 26 managed by the administrator. An example of the supplier administration web page is shown as a web page 602, in FIG. 6, accessed by an administrator, via client device 26, from RFP server 14. An administrator uses input device 112 of client device 26 to provide a set of factors, such as, a name of a supplier, a state in which a place of business of the supplier is located, a country in which the place of business is located, a number of RFP reports completed by the supplier, a number of RFPs not closed and sent to the supplier for preparing responses to the RFPs, a status as to whether the supplier is actively conducting business or not conducting business, or a permission provided to the supplier on the web page 602, and the supplier selects a search button on the web page to search for the RFP reports or the RFPs. Upon selection of the search button on web page 602, the processor of client device 26 requests RFP server 14 to provide a set of search results 606 that meet the factors and the search results are displayed on output device 108.

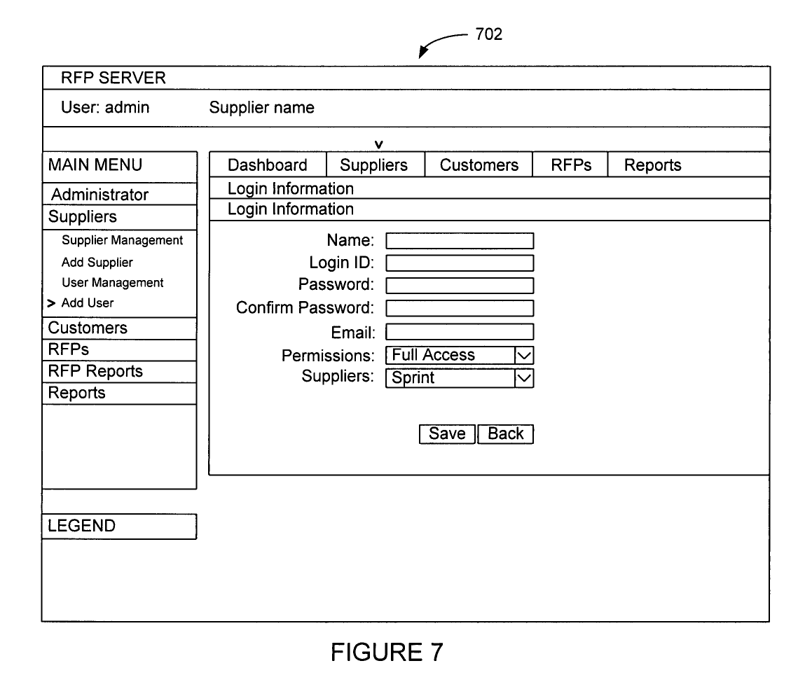

Upon displaying the supplier administration web page and upon receiving a selection of an add supplier option on the supplier administration web page, the processor of client device 26 displays, via output device 108, a supplier-login web page and receives 314 supplier user data from an administrator on the supplier-login web page. Examples of the supplier user data include a login name of a supplier, a login identification of the supplier, an email address of the supplier, a password of the supplier, permissions for the supplier, and a name of the supplier. An example of the supplier-login web page is shown as a web page 702 in FIG. 7. When an administrator provides, via input device 112 of client device 26, the supplier user data to the processor of the client device and selects a save button on web page 702, RFP server 14 receives from the processor the supplier user data.

An administrator uses client device 26 to select a plurality of permissions for a supplier. For example, an administrator selects a plurality of permissions for a supplier having a login identification. As another example, an administrator selects a plurality of permissions for a supplier having email address. Upon selection of the permissions for a supplier, processor of client device 26 receives the permissions and an administrator, via input device 112 of the client device, saves the permissions within RFP server 14. For example, RFP server 14 executes the method for generating an RFP and responding to the RFP to display a web page to an administrator and the web page provides a plurality of permissions from which the administrator can select some of the permissions. Examples of the permissions for a supplier include whether the supplier receives an RFP or a communication from a customer from an industry other than that of the supplier, whether the supplier can access an RFP from RFP server 14, whether the supplier has access, from RFP server 14, to communications between another supplier and a customer, whether the supplier can send an RFP response to a customer, and whether the supplier can send a communication related to the RFP response to a customer. A customer may not desire to receive an RFP response or a communication related to the RFP response from a supplier that the customer is unhappy with for not providing timely service or for providing an expensive product or service to the customer. Examples of industries include clothing industry, medical devices industry, government industry, real estate industry, telecommunications network equipment industry, sports industry, movie industry, cattle industry, gaming industry, shipping industry, and motor vehicle industry, and one of these industries is other than any of the remaining industries.

The processor within client device 26 determines 318 whether the supplier user data received 314 is unique. For example, the processor of client device 26 accesses a login name of another supplier stored within the database of RFP server 14 and determines whether the name matches a login name of supplier received 314 by the processor. As another example, the processor of client device 26 accesses an email address of another supplier stored within the database of RFP server 14 and determines whether the email address matches an email address of a supplier received 314 by the processor. As yet another example, the processor of client device 26 accesses a password of another supplier stored within the database of RFP server 14 and determines whether the password matches a password of supplier received 314 by the processor.

Upon determining that the supplier user data received by processor of client device 26 managed by an administrator is not unique, the processor continues to provide an option to the administrator to change the supplier user data and receive 314 the changed supplier user data. The processor of client device 26 continues to prompt an administrator to continue to provide changed supplier user data until the processor determines that the changed supplier user data is unique.

Upon determining 318 that the supplier user data regarding a supplier is unique, the processor of client device 26 creates 322 a supplier profile and communicates the supplier profile to RFP server 14. The supplier profile includes the information regarding a supplier and the supplier user data. RFP server 14 stores the supplier profile within the database of the RFP sever 14.

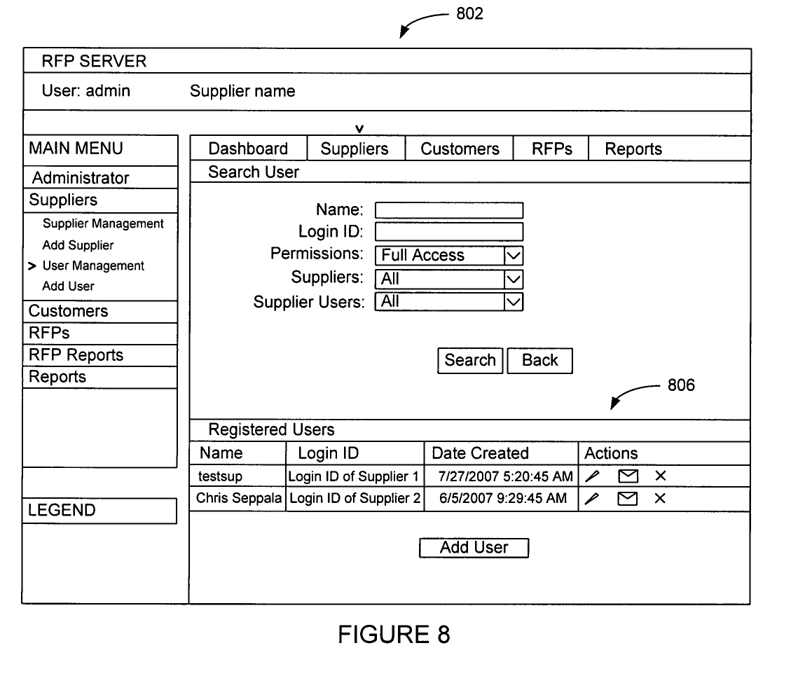

Upon receiving a selection of a user management option within the supplier administration web page from an administrator, the processor of client device 26 requests a search-supplier-user web page from RFP server 14. Upon receiving the search-supplier-user web page from RFP server 14, the processor of client device 26 displays the web page to an administrator. An example of the search-supplier-user web page is shown as a web page 802 in FIG. 8. The processor of client device 26 receives, from an administrator, a set of criteria, such as, a login name of a supplier, a login identification of the supplier, or permissions for the supplier, and receives, from the administrator, a selection of a search button to search for a supplier based on the criteria and generates a set of search results 806 meeting the criteria.

Upon storage of the supplier profile within RFP server 14, the processor of client device 26 sends an email including a hyperlink to an RFP supplier login page, a login name of a supplier, and a password of the supplier to the supplier, and client device 34 managed by the supplier receives 402 the email. Upon receipt 402, by processor of client device 34, of an email including a hyperlink to the RFP supplier login page from an administrator, a supplier accesses, via input device 112 of the client device, the hyperlink and the access generates 406 a display of the RFP supplier login page on client device 34.

Upon generation 406 of a display of the RFP supplier login page, a supplier enters a login name and a password of the supplier provided via an email received 402 from an administrator. Upon receiving 410 a login name and a password entered by a supplier, the processor of client device 34 validates 414 the login name and the password. The processor of client device 34 validates 414 a login name and a password received 410 on the RFP supplier login page by comparing the login name and the password with a login name and a password stored within the supplier profile stored in RFP server 14.

Upon determining that there is a match, the processor of client device 34 provides an option to a supplier to change a password of the supplier within the supplier profile. If a supplier decides to change a password of the supplier, the processor of client device 34 receives 418 the changed password, changes 422 the password within the supplier profile to the changed password, and directs 426 a supplier to a supplier home page. Processor of client device 34 accesses the supplier home page from RFP server 14 and displays the home page on output device 108 of the client device. On the other hand, if a supplier decides not to change a password of the supplier within the supplier profile, the processor of client device 34 managed by the supplier does not receive 418 the changed password from the supplier and directs 426 the supplier to the supplier home page.

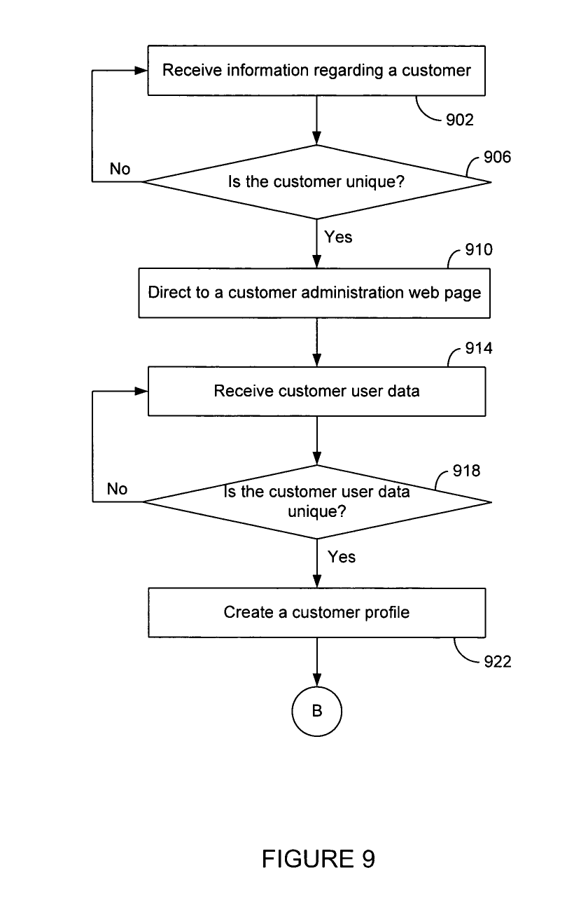

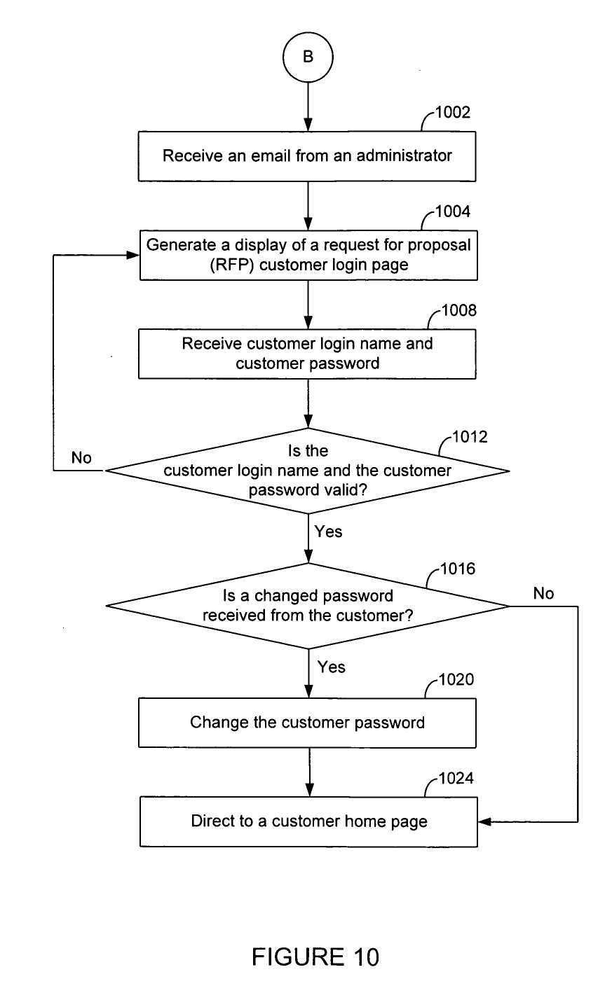

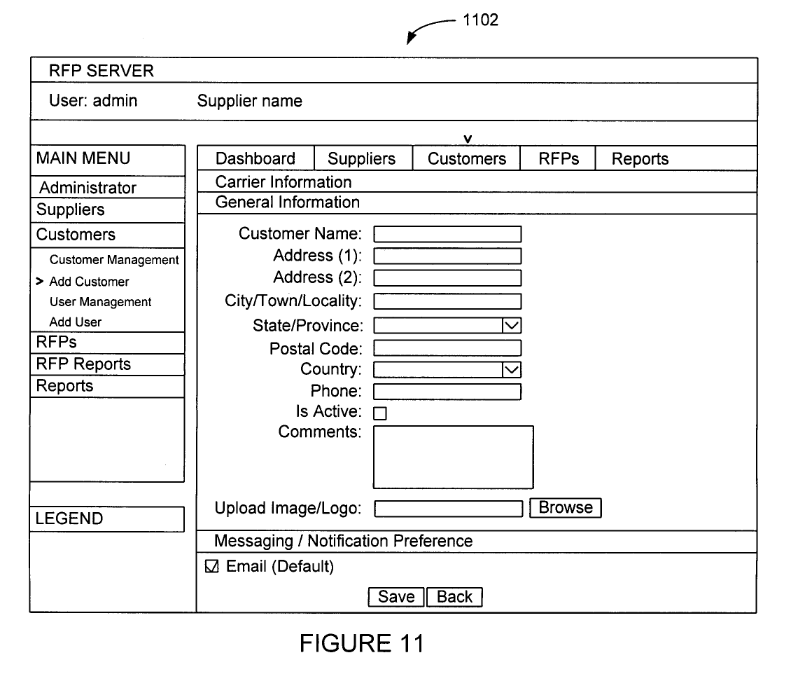

FIGS. 9 and 10 are a flowchart and FIGS. 11, 12, 13, 14, and 15 are web pages describing an embodiment of a method for generating an RFP and responding to the RFP. The processor within client device 26 managed by an administrator receives 902 information regarding a customer from the administrator. For example, the processor within client device 26 receives, from an administrator, a name of a customer, a uniform resource locator (URL) of the customer, a business address of the customer, and any other information, such as a description of services or products offered by the customer. As another example, the processor within client device 26 provides an administrator access to a web page 1102, shown in FIG. 11, from RFP server 14 and the processor receives, from the administrator, on the web page, a name of a customer, a street or postal office box address of a place of business of the customer, a city of in which the place of business is located, a state in which the place of business is located, a country in which the place of business is located, a phone of the place of business, a status as to whether the customer is actively conducting business or not conducting business, an image, such as a trademark or a service mark, of the customer, and other comments regarding the customer. An administrator accesses web page 1102 from RFP server 14 by providing a login identification and a password to the server. Before the processor within client device 26 receives 902 information regarding the customer from an administrator, the administrator receives via a medium, such as electronic mail, telephone, or the Internet, the information from the customer.

The processor within client device 26 determines 906 whether information received 902 regarding a customer is unique. For example, the processor within client device 26 accesses a name of another customer stored within database of RFP server 14 and determines whether the name matches a name of customer received 902 by the processor. As another example, the processor within client device 26 accesses a URL of another customer stored within database of RFP server 14 and determines whether the URL matches a URL of customer received 902 by processor.

Upon determining 906 that the information regarding the customer received by the processor within client device 26 is not unique, the processor continues to provide an option to the administrator to change the information and receive 902 the changed information. The processor within client device 26 continues to prompt an administrator to continue to provide changed information until the processor determines that information regarding a customer is unique.

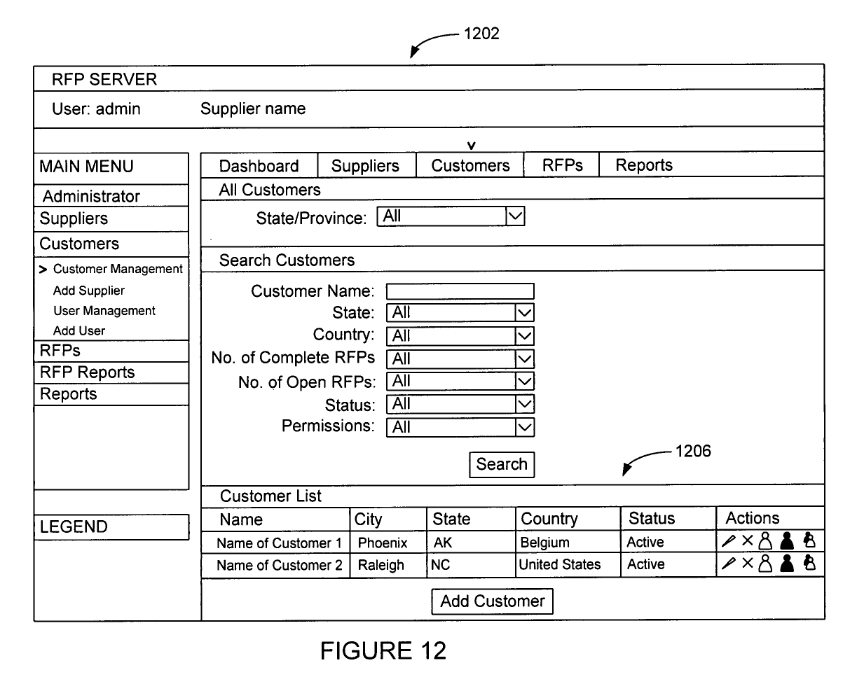

Upon determining 906 that information received 902 regarding a customer is unique, the processor within client device 26 directs 910 an administrator to a customer administration web page stored within RFP server 14 and the customer administration web page is displayed on output device 118 of the client device. An example of the customer administration web page is shown as a web page 1202, in FIG. 12, accessed by an administrator, via client device 26, from RFP server 14. An administrator uses input device 112 of client device 26 to provide a set of parameters, such as, a name of a customer, a state in which a place of business of the customer is located, a country in which the place of business is located, a number of RFPs saved, via the input device, by the customer, a number of RFPs not closed and sent to a supplier for preparing responses to the RFPs, a status as to whether the customer is actively conducting business or not conducting business, or a permission provided to the customer on web page 1202, and the administrator selects a search button on the web page to search for the RFPs that meet the parameters. Upon selection of the search button on web page 1102, the processor of client device 26 requests RFP server 14 to provide a set of search results 1206 that meet the parameters and the search results are displayed on output device 108 of client device 26.

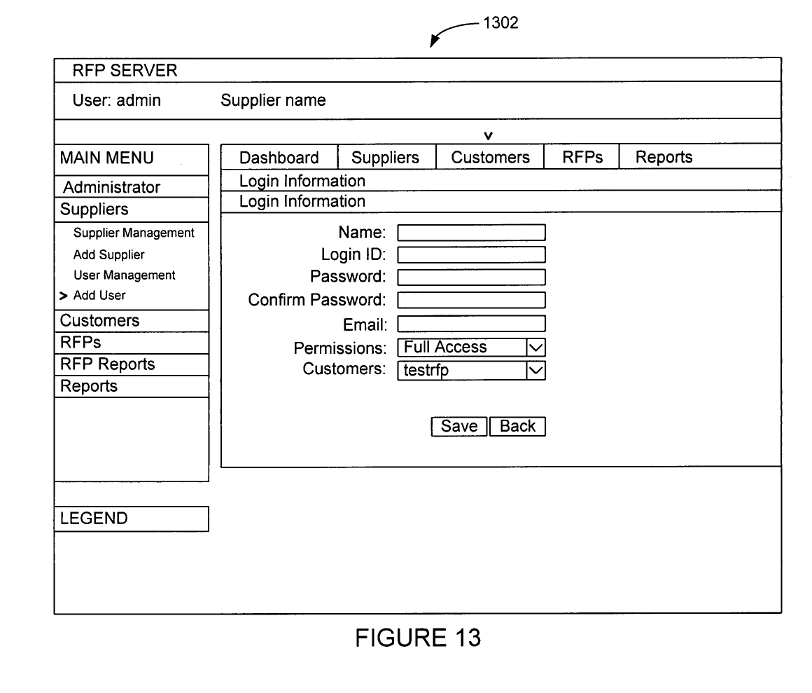

Upon displaying the customer administration web page and upon receiving a selection of an add customer option on the customer administration web page, the processor of client device 26 displays, via output device 108, a customer-login web page and receives 914 customer user data from an administrator on the customer-login web page. Examples of the customer user data include a login name of a customer, an email address of the customer, a password of the customer, an email address of the customer, permissions for the customer, and a name of the customer. An example of the customer-login web page is shown as a web page 1302 in FIG. 13. When an administrator provides, via input device 112 of client device 26, the customer user data to the processor of the client device and selects a save button on web page 1302, RFP server 14 receives from the processor the customer user data.

An administrator uses client device 26 to select a plurality of permissions for a customer and saves the permissions within RFP server 14. For example, RFP server 14 executes the method for generating an RFP and responding to the RFP to display a web page to an administrator and the web page provides a plurality of permissions from which the administrator can select some of the permissions. Examples of the permissions for a customer include whether the customer can request an RFP response from or send a communication to a supplier from an industry other than that of the customer, whether the customer can send an RFP or a communication to a particular supplier, and whether the customer has access to communications between another customer and a supplier. In the example, an administrator indicates, via input device 112, to the processor of client device 26 that a customer is not permitted to send an RFP or a communication related to the RFP to a supplier that does not desire to receive the RFP or the communication from the customer. A supplier may not desire to receive an RFP or a communication related to the RFP from a customer that the supplier is unhappy with for reasons, such as, being too demanding, being stringent, or making late payments after delivery of a product or service.

The processor of client device 26 determines 918 whether the customer user data received 914 is unique. For example, the processor of client device 26 accesses a login name of another customer stored within database of RFP server 14 and determines whether the name matches a login name of customer received 914 by processor. As another example, the processor of client device 26 accesses an email address of another customer stored within database of RFP server 14 and determines whether the email address matches an email address of customer received 914 by processor. As yet another example, the processor of client device 26 accesses a password of another customer stored within database of RFP server 14 and determines whether the password matches a password of customer received 914 by processor.

Upon determining that the customer user data received by processor of client device 26 managed by an administrator is not unique, the processor continues to provide an option to the administrator to change the customer user data and receive 914 the changed customer user data. The processor of client device 26 continues to prompt an administrator to continue to provide changed customer user data until the processor determines that the changed customer user data is unique.

Upon determining 918 that the customer user data regarding a customer is unique, the processor of client device 26 creates 922 a customer profile and communicates the customer profile to RFP server 14. The customer profile includes the information regarding a customer and the customer user data. RFP server 14 stores the customer profile in the database of the RFP server.

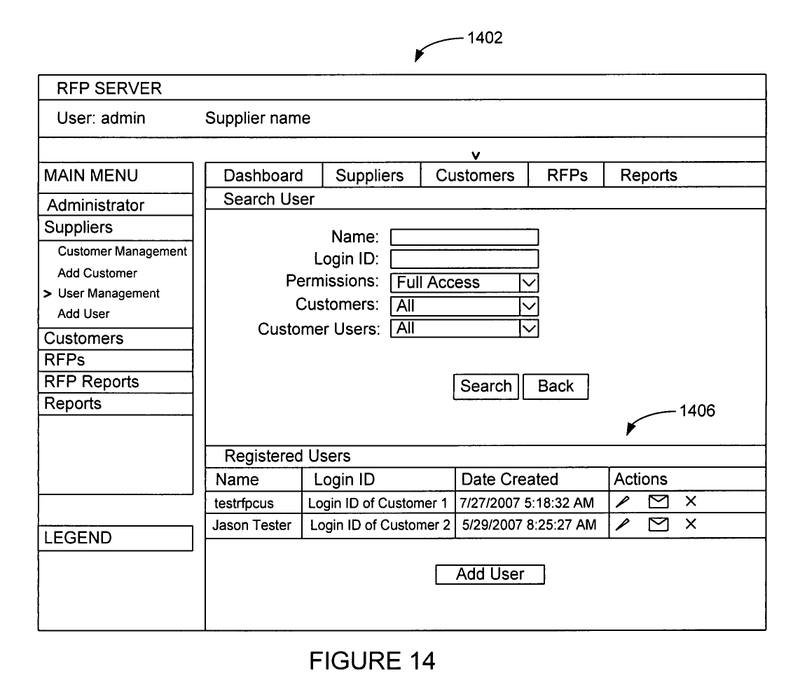

Upon receiving a selection of a user management option within the customer administration web page from an administrator, the processor of client device 26 requests a search-customer-user web page from RFP server 14. Upon receiving the search-customer-user web page from RFP server 14, the processor of client device 26 displays, via output device 108, the web page to an administrator. An example of the search-customer-user web page is shown as a web page 1402 in FIG. 14. The processor of client device 26 receives a set of variables, such as, a login name of a customer, a login identification of the customer, or permissions for the customer, and receives a selection of a search button to search for a customer based on the variables and generates a set of search results 1406 meeting the variables.

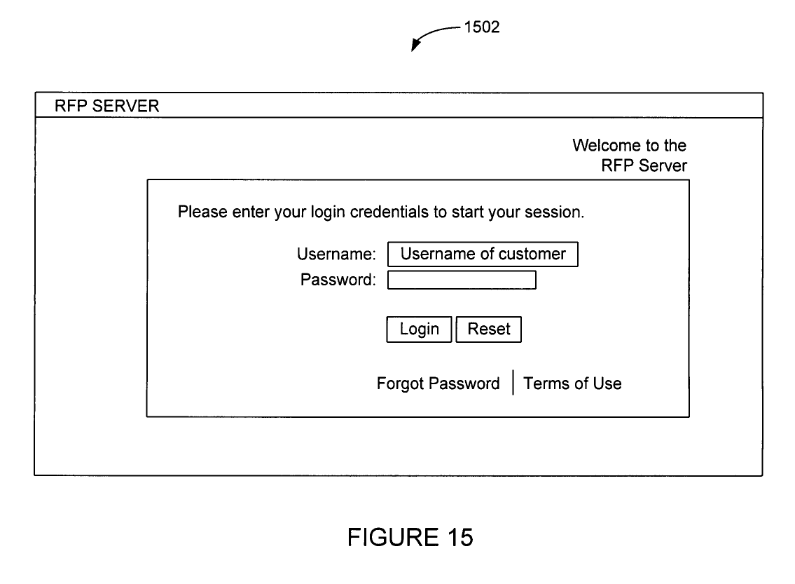

Upon storage of the customer profile within the RFP server 14, the processor of client device 26 sends an email including a hyperlink to an RFP customer login page, a login name of a customer, and a password of the customer to the customer, and client device 22 managed by the customer receives 1002 the email. Upon receipt 1002 of an email including a hyperlink to the RFP customer login page from an administrator, a customer accesses the hyperlink and the access generates 1004 a display of the RFP customer login page on client device 22 managed by the customer. An example of the RFP customer login page is shown as a web page 1502 in FIG. 15.

Upon generation 1004 of a display of the RFP customer login page, the processor of client device 22 managed by a customer receives 1008 a login name and a password that is entered by the customer and that is provided to the customer via an email received 1002. Upon receiving 1008 a login name and a password from a customer, the processor of client device 22 validates 1012 the login name and the password. The processor of client device 22 validates 1012 a login name and a password received 1008 from a customer on the RFP customer login page by comparing the login name and the password with a login name and a password within the customer profile stored in RFP server 14.

Upon determining that there is a match between a login name and a password received 1008 from a customer on the RFP customer login page and a login name and a password within the customer profile, the processor of client device 22 provides an option to a customer to change the password of the customer within the customer profile. If a customer decides to change a password of the customer, the processor of client device 22 receives 1024 the changed password, changes 1020 the password within the customer profile to the changed password, and directs 1024 a customer to a customer home page. Processor of client device 22 accesses the customer home page from RFP server 14 and displays the home page on output device 118 of the client device. On the other hand, if a customer decides not to change a password of the customer within the customer profile, the processor of client device 22 managed by the customer does not receive 1016 the changed password from the customer and directs 1024 the customer to the customer home page.

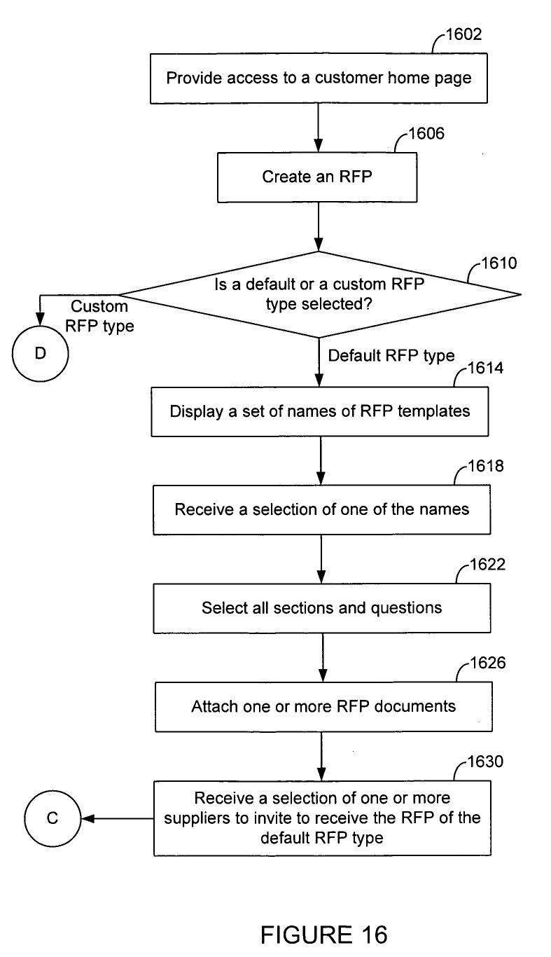

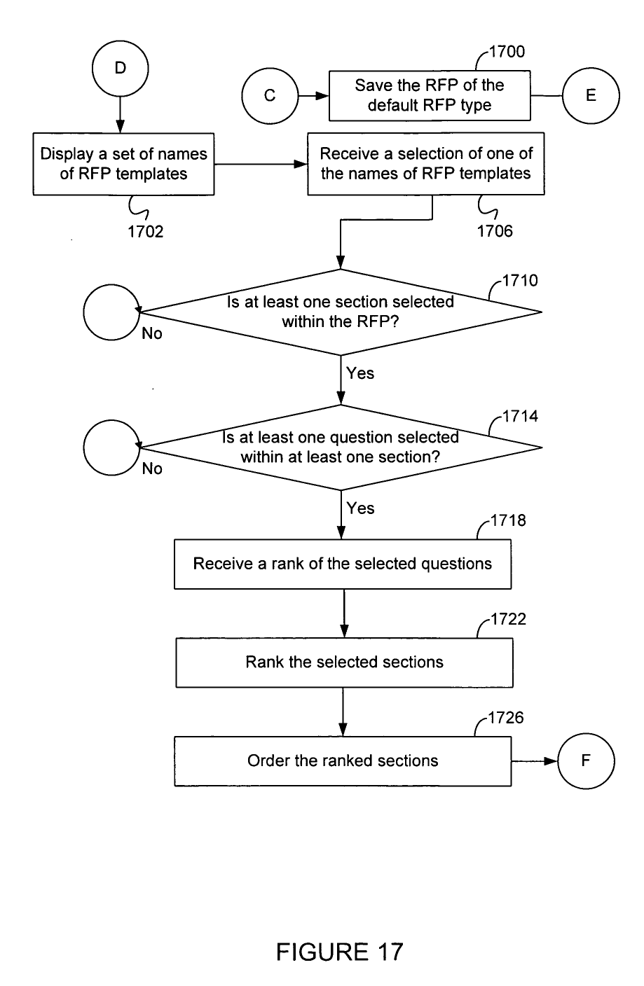

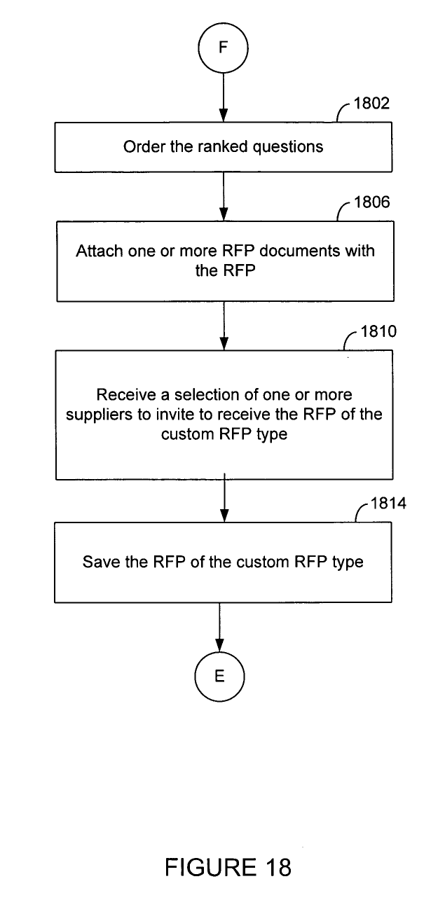

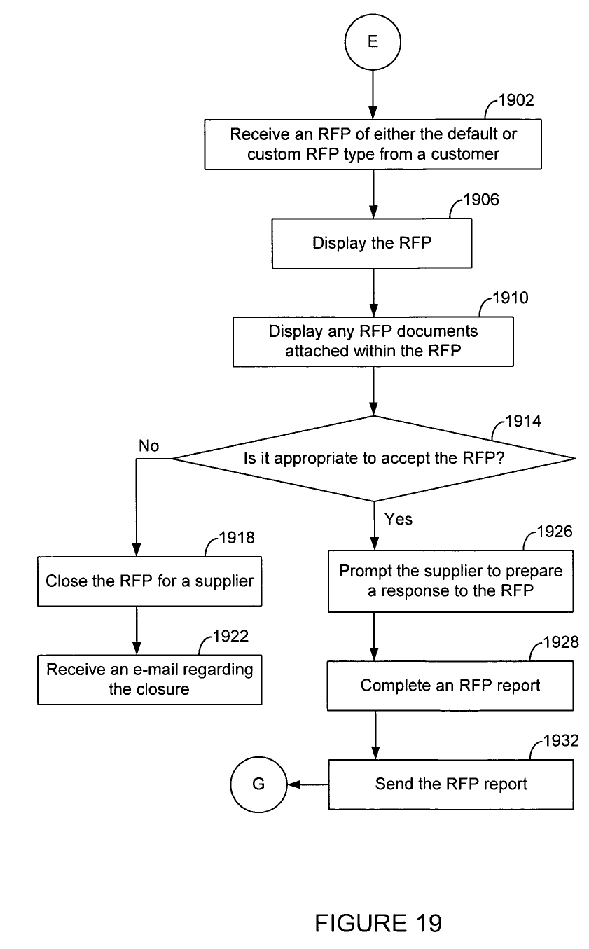

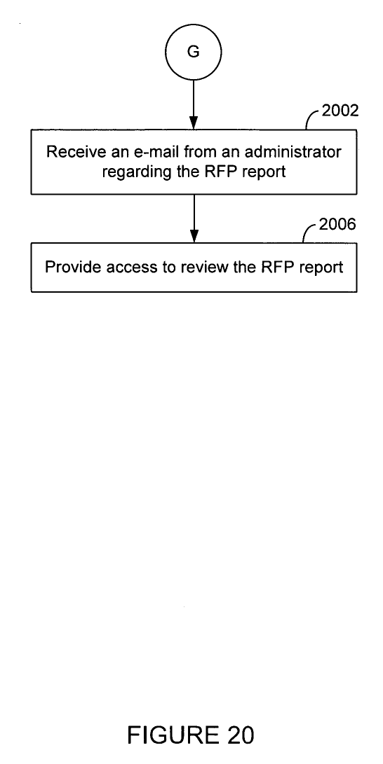

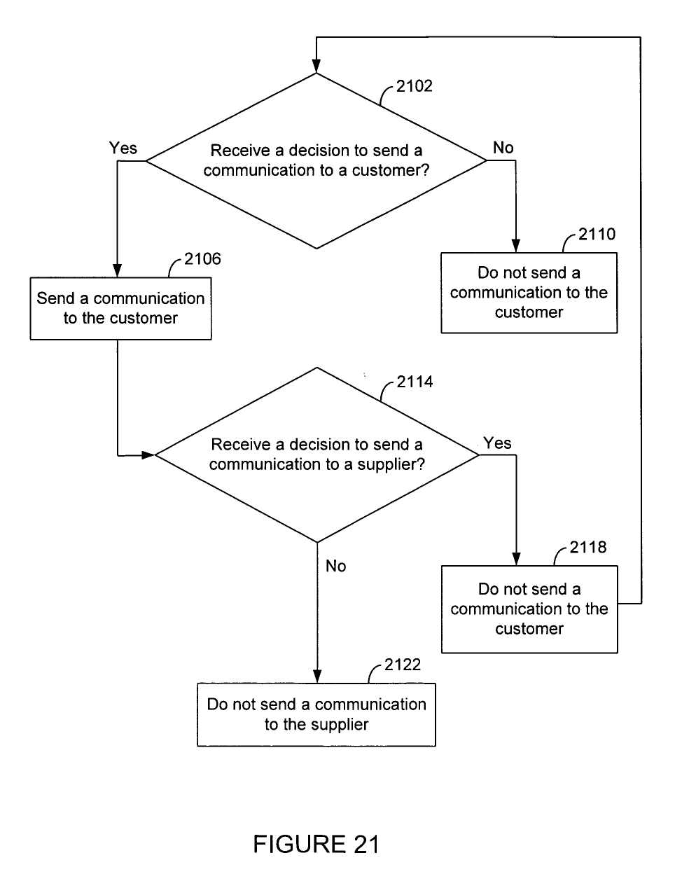

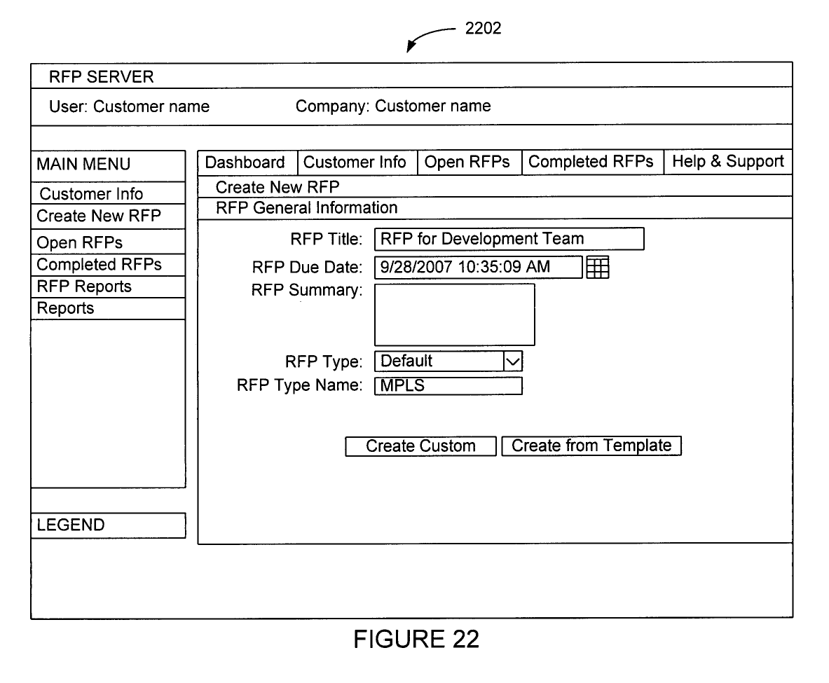

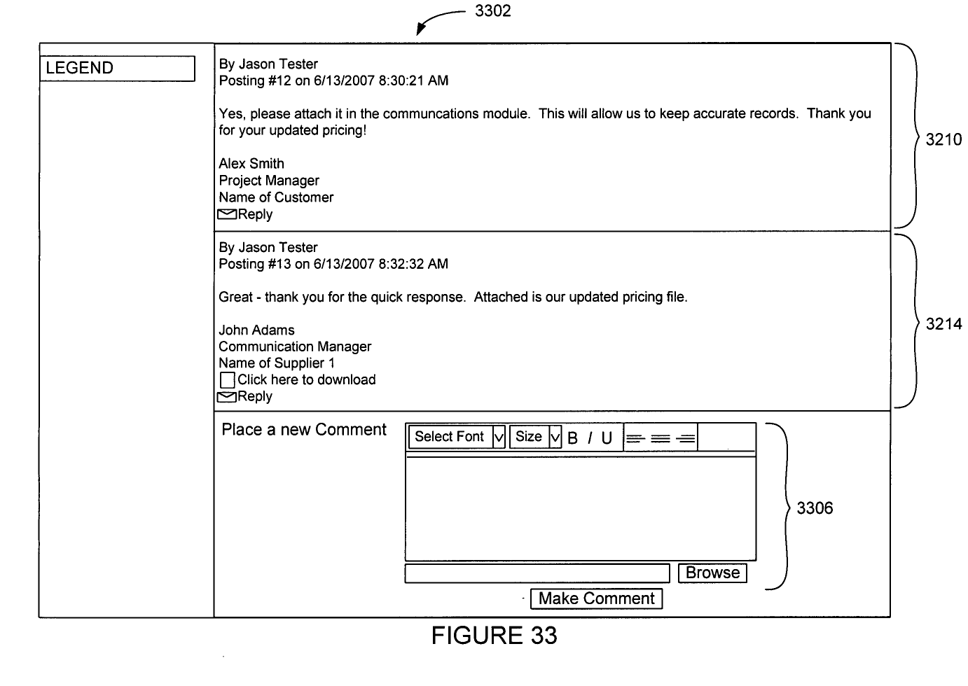

FIGS. 16, 17, 18, 19, 20, and 21 are flowcharts and FIGS. 22, 23, 24, 25, 26, 27, 28, 29, 30, 31, 32, and 33 are web pages of embodiments of a method for generating and responding to an RFP. Upon receiving a login name and a password from a customer, processor of client device 34 provides access 1602 to the customer home page to the customer. The customer home page displays to a customer a selection stating to create 1606 an RFP. A customer selects, via an input device 112 of the client device 22, the selection stating to create 1606 an RFP. Upon receiving a selection stating to create 1606 an RFP from a customer, the processor of client device 22 requests from RFP server 14 a create-RFP web page, which includes an option to the customer to select a type of RFP. The types of RFP include a custom RFP type and a default RFP type. Examples of RFPs of the default RFP type include a plurality of RFP templates. An example of the create-RFP web page is shown as a web page 2202 in FIG. 22. A customer uses input device 112 of client device 22 to provide, on web page 2202, a title of an RFP, a due date for providing the RFP report based on the RFP, a summary of the RFP, a type of the RFP, or a name of the type of RFP to RFP server 14. A customer also uses input device 112 of client device 22 to select either a create-custom button or a create-from-template button to designate to RFP server 14 whether an RFP to be created is of the default RFP type of the custom RFP type.

Each RFP template includes one or more sections and one or more questions. Examples of sections include a service level agreement (SLA) section, a general terms and conditions section including questions regarding the general terms and conditions for providing a product or a service to a customer, a general miscellaneous section, a redundancy section, a management section including questions regarding quality of management in providing a product or service to the customer, a support section including questions regarding technical support and/or customer support provided by a supplier to the customer, an implementation section including questions regarding quality of implementation of the product or service, a technology section including questions regarding technical specifications of the product, and a network section including questions regarding technical specifications of a network compatible with the product. Examples of questions include an availability question requesting time of availability of a supplier during weekends or weekdays, a jitter question asking whether a particular product requested by a customer from the supplier has experienced jitter, an uptime question asking whether a ratio between uptime and downtime of the product exceeds a certain threshold, a packet-delivery question asking whether the supplier has experienced problems with packet delivery via the product, an SLA metrics question asking to provide URLs or documents detailing a set of SLA metrics, and a latency question asking whether a latency experienced by packets of data communicated via the product exceeds a certain amount of time. Examples of the SLA metrics include abandon rate (ABA), which is a percentage of calls to a supplier abandoned while waiting to be answered and an average speed to answer (ASA), which is an average amount of time taken to answer a call by a service desk of the supplier.

Upon determining 1610 that a selection of the default RFP type is received from a customer, processor of client device 22 displays 1614, via output device 108, names of RFP templates to the customer. Upon receiving 1618, from a customer, a selection of a name of an RFP template from among the names of RFP templates displayed to the customer, processor of client device 22 selects 1622 all sections and questions from the RFP template.

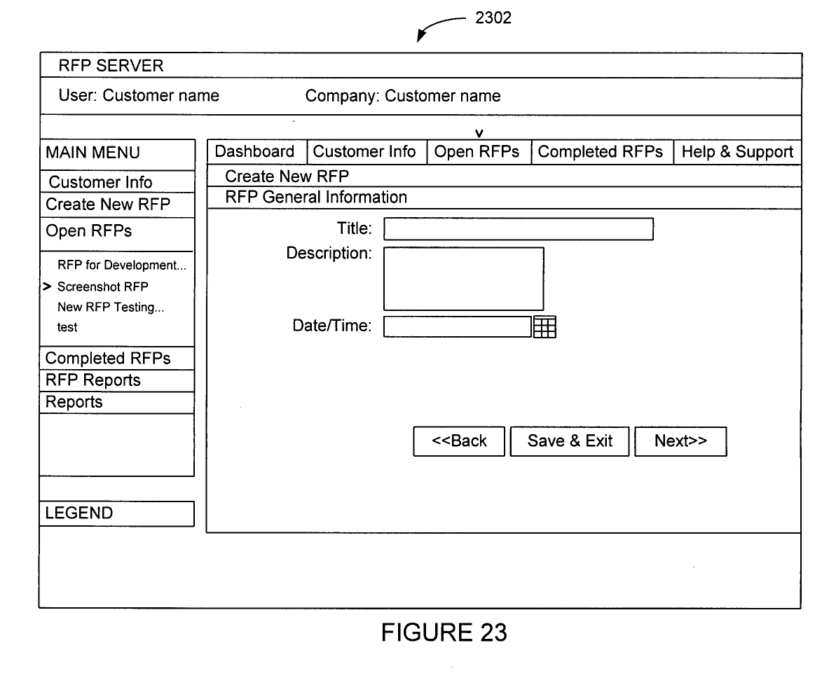

Upon selecting 1622 all sections and questions within an RFP template, the processor of client device 22 prompts a customer to attach one or more RFP documents. Examples of RFP documents to attach to an RFP include a drawing describing a product or a service desired by a customer, a photo describing the product of service, a written description of the product of service, an email describing the product or service, a pricing desired by the customer of the product or service, legal documents regarding the product or service, or technical specifications of the product or service. RFP server 14 stores the RFP documents within the database of the server. The processor of client device 22 receives one or more RFP documents from a customer and attaches 1626 the one or more RFP documents to the sections and questions within the RFP template. An example of a web page 2302 showing one or more RFP documents attached to the sections and questions within the RFP template is shown in FIG. 23.

Upon attaching 1626 one or more RFP documents, processor of client device 22 provides an option to a customer to invite one or more suppliers. When a customer selects, via input device 112, the option to invite one or more suppliers, processor of client device 22 provides one or more names of suppliers that are displayed, via output device 108, of the client device to the customer. The names of suppliers that are displayed to a customer are based on at least one of the permissions for the suppliers and the permissions for the customer. For example, upon determining that a supplier offers a product or a service within an industry other than that of a customer that invites one or more suppliers, processor of client device 22 does not display names of suppliers within the industry other than that of the customer to the customer. As another example, upon determining that a supplier is red flagged as not providing timely delivery of a product or service or providing expensive services to a customer, processor of client device 22 does not display a name of the supplier to the customer. As yet another example, upon determining that a supplier has indicated that the supplier is unhappy with a customer, processor of client device 22 does not display a name of the supplier to the customer. In another embodiment, the names of suppliers that are displayed to a customer are independent of the permissions for the suppliers and the permissions for the customer.

Upon viewing a display of one or more names of one or more suppliers, a customer selects, via input device 112 of client device 22, managed by the customer, to send an RFP template with all selected sections and all selected questions, and with any attached RFP documents to the customer. Upon receiving 1630 a selection from a customer of one or more names of one or more suppliers for sending the RFP template, processor of client device 22 saves, within the memory device of client device 22, an RFP including the RFP template with all selected sections and questions and with any attached RFP documents, and including one or more names of one or more suppliers selected. An RFP of the default RFP type is generated by executing 1606, 1610, 1614, 1618, 1622, 1626, and 1630 of the computing module.

RFP server 14 receives an RFP of the default RFP type output from processor of client device 22 and saves 1700 the RFP within the database of memory device of RFP server 14. A customer assigns, via input device 112 of client device 22, a name to an RFP saved within RFP server 14. Examples of a name of an RFP include RFP for Sprint™ and RFP for Intel™.

Upon determining 1610 that a selection of the custom RFP type is received from a customer, processor of client device 22 displays 1702, via output device 108 of the client device, names of the RFP templates to the customer. Upon receiving 1706, from a customer, a selection of a name of an RFP template from among the names of the RFP templates displayed to the customer, processor of client device 22 provides an option to the customer to select one or more sections from the RFP template.

In one embodiment, upon receiving 1706, from a customer, a selection of a name of an RFP template from among the names of the RFP templates displayed to the customer, processor of client device 22 provides an option to the customer to add additional questions and additional sections within the RFP template selected. Upon receiving the option to add additional questions and additional sections, a customer, via input device 112 of client device 22, types the additional questions and additional sections into the RFP template of the custom RFP type selected, or pastes the additional questions and additional sections into the RFP template, or imports the additional questions and sections from a document, such as a Microsoft™ Excel™ spreadsheet document or a Microsoft™ Word™ document, into the RFP template.

Upon determining 1710 that a selection of at least one section is not received from a customer via input device 112 of client device, processor of the client device 22 continues to provide the option to select one or more sections from an RFP template. On the other hand, upon determining 1710 that a selection of one or more sections within an RFP template is received from a customer, processor of client device 22 provides an option to the customer to select 1714 one or more questions within the selected one or more sections.

Upon determining 1714 that at least one question is not selected by a customer via input device 112 of client device 22, the processor of the client device continues to provide the option to select one or more questions within the selected one or more sections. On the other hand, upon determining 1714 that a selection of one or more questions within the selected one or more sections is received from a customer, processor of client device 22 provides an option to a customer to rank the one or more selected questions.

A customer ranks one or more selected questions based on a desired order of importance. For example, a customer wishes to provide a higher rank, such as 3, to a question regarding pricing of a product or service than a rank, such as 1, provided to a question regarding timeliness of delivery of the product or service. As another example, a customer wishes to allocate a higher rank to a question regarding a quality of a product or service than a rank allocated to pricing of the product or service. As yet another example, a customer ranks a question within an RFP by selecting the question via input device 112 of client device 22 and selecting a rank of the question from a drop-down list. In another embodiment, upon determining 1714 that a selection of one or more questions within the selected one or more sections is received from a customer and before receiving a ranking of the one or more selected questions, processor of client device 22 provides an option to the customer to edit the selected one or more questions.

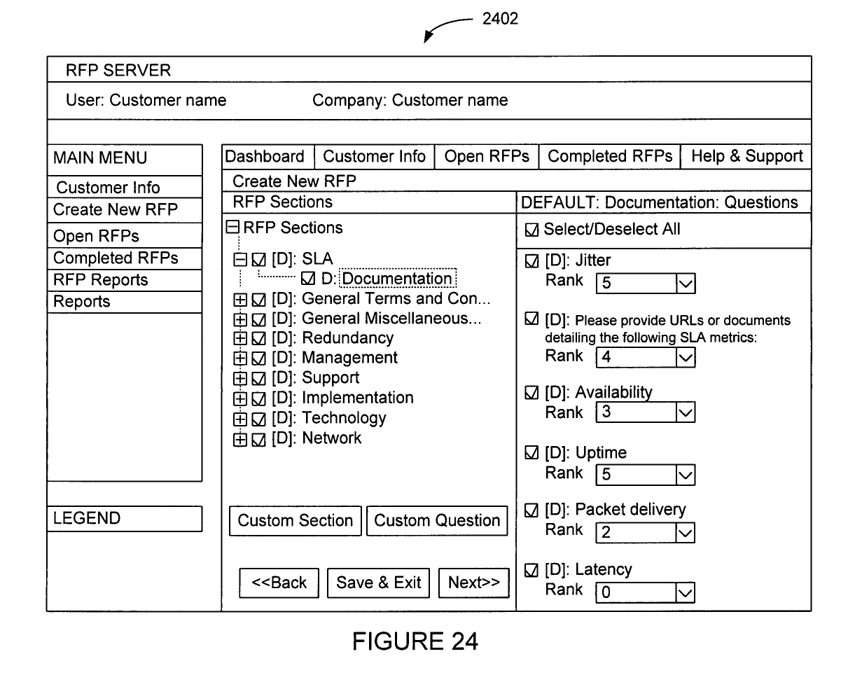

Processor receives 1718 a rank, from a customer via input device 112 of client device 22, of the one or more selected questions from a customer and ranks 1722 the selected one or more sections based on the ranks of the questions. As an example, processor of client device 22 ranks a section as an average of ranks of questions within the section. As another example, processor of client device 22 ranks a section as a median of ranks of questions within the section. A web page 2402 in FIG. 24 shows exemplary rankings, such as from 5 thru 0, of one or more selected questions within a particular section. On the web page 2302, a section is ranked 4, which is a rounding of an average of ranks of all questions in the section.

Processor of client device 22 orders 1726 the ranked one or more sections based on the ranks of the sections. For example, processor of client device 22 displays, on top on output device 108 of the client device, a section ranked the highest and displays, below the top on the output device, a section ranked the second highest. As another example, processor of client device 22 displays, on top on output device 108 of the client device, a section ranked the lowest and displays, below the top on the output device, a section ranked the second lowest.

Processor of client device 22 orders 1802 the ranked one or more questions within a section based on the ranks of the questions. For example, processor of client device 22 displays, on top on output device 108 of the client device, a question ranked the highest within a section and displays, below the top on the output device 108, a question ranked the second highest within the section. As another example, processor of client device 22 displays, on top on output device 108 of the client device, a question ranked the lowest within a section and displays, below the top on the output device 108, a question ranked the second lowest within the section.

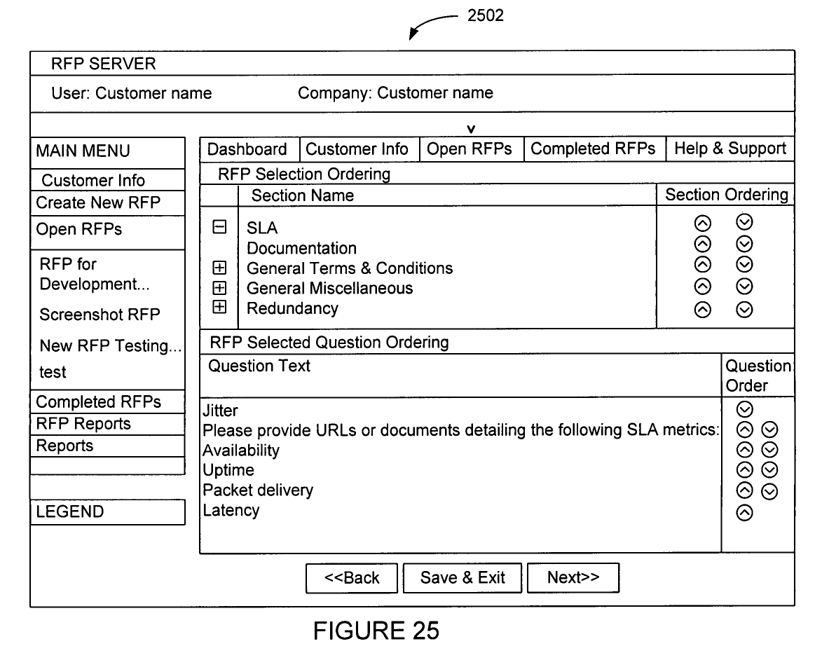

A web page 2502 in FIG. 25 shows an example of an order of sections based on a rank of the sections and an order of questions based on a rank of the questions. On web page 2502, the SLA section, ranked the highest, is ordered at the top of web page, the general terms and conditions section, ranked the second highest, is ordered below the SLA section, the general miscellaneous section, ranked the third highest, is ordered below the general terms and conditions section, and the redundancy section, ranked the fourth highest, is ordered below the general miscellaneous section. Moreover, within the web page 2502, questions within the SLA section are ordered based on their ranks. On the web page 2502, the jitter question, ranked the highest, is ordered on top of the SLA metrics question, the SLA metrics question, ranked the second highest, is ordered below the jitter question, and the availability question, ranked the third highest, is ordered below the SLA metrics question.

Moreover, web page 2502 includes arrows for each section and each question. The arrows are generated by RFP server 14. When a customer selects, via input device 112 of client device 22, an up arrow corresponding to a particular section or question on web page 2502, processor of client device 22 changes an order of the section of question. For example, when a customer selects a down arrow linked to the general miscellaneous section on web page 2502, processor of client device 22 moves the general miscellaneous section from a position above the redundancy section to a position directly below the redundancy section on web page 2502. As another example, when a customer selects an up arrow linked to the latency question on web page 2502, processor of client device 22 moves the latency question from a position below the packet delivery question to a position between the packet delivery question and the uptime question on web page 2502.

In another embodiment, the method for generating and responding to an RFP does not include 1718, 1722, 1726, and 1802. In still another embodiment, the method does not include 1722 and 1726. In yet another embodiment, processor of client device 22 receives a rank, from a customer, of a section and the rank is independent of a rank of one or more questions within the section.

In one embodiment, if processor of client device 22 does not receive a rank of a set of questions within an RFP, the processor does not order the questions based on the rank and leaves the order as is. In another embodiment, when processor of client device 22 receives one or more ranks from a customer of one or more sections within an RFP and the rank is independent of one or more ranks of one or more questions within the section, the processor does not order any sections within the RFP that do not receive a rank from the customer.

Upon ordering 1802 the ranked one or more questions, processor of client device 22 prompts a customer to attach one or more RFP documents. Processor of client device 22 receives one or more RFP documents from a customer and attaches 1806 the one or more RFP documents to the ordered one or more sections and to the ordered one or questions.

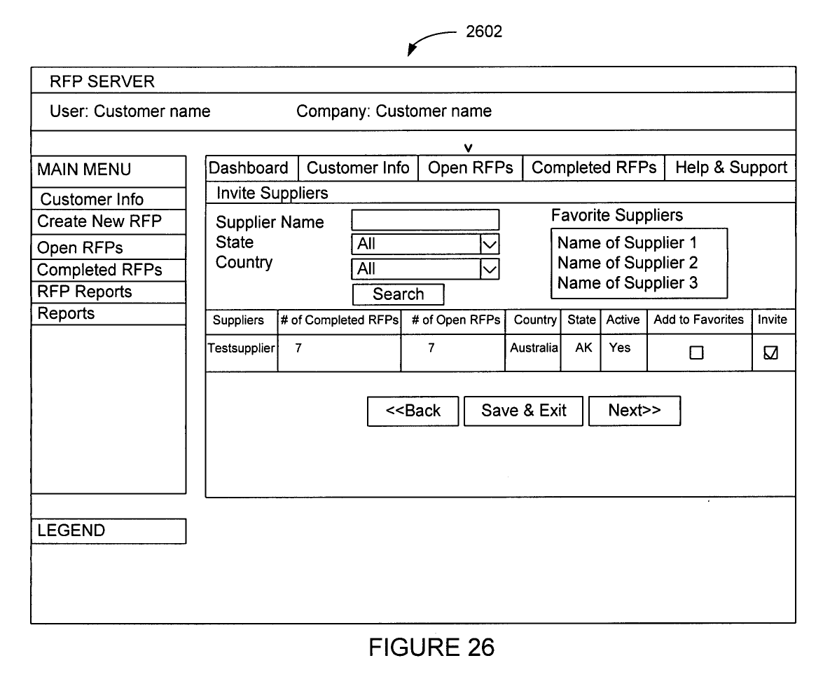

Upon attaching 1806 one or more RFP documents, processor of client device 22 provides an option to a customer to invite one or more suppliers. An exemplary web page 2602 showing an option to invite one or more suppliers is shown in FIG. 26. The processor of client device 22 accesses web page 2602 from RFP server 14 and displays the web page on output device 108 of the client device to a customer. Web page 2602 includes a name of a supplier to be invited, a state in which a place of business of the supplier is located, and a country in which the place of business is located. A customer enters the name, the state, or the country to obtain a list of suppliers on web page 2602 to be invited. When a customer selects, via input device 112, the option to invite one or more suppliers, processor of client device 22 provides one or more names of suppliers that are displayed, via output device 108, of the client device to the customer. The names of suppliers that are displayed to a customer are based on at least one of the permissions for the suppliers and the permissions for the customer.

Upon viewing a display of one or more names of one or more suppliers, a customer selects, via input device 112 of client device 22 managed by the customer, one or more of the names to send the ordered one or more sections and the ordered one or more questions with any attached RFP document to the customer. Upon receiving 1810 a selection from a customer of one or more names of one or more suppliers for sending the ordered one or more sections and the ordered one or more questions with any attached RFP document, processor of client device 22 saves 1814, within the memory device of RFP server 14, an RFP including the ordered one or more sections and the ordered one or more questions with any attached RFP document, and including one or more names of one or more suppliers received 1810 for invitation. An RFP of the custom RFP type is generated by executing 1606, 1610, 1702, 1706, 1710, 1714, 1718, 1722, 1726, 1802, 1806, 1810, and 1814 of the computing module. RFP server 14 receives an RFP of the custom RFP type output from processor of client device 22 and stores the RFP within RFP server 14.

Processor of client device 34 managed by a supplier who accesses the supplier home page receives 1902, via RFP server 14, an RFP of either the custom RFP type or the default RFP type from client device 22 managed by a customer that invited the supplier to prepare a response to the RFP. When a supplier accesses the supplier home page, RFP server 14 does not allow the supplier to access an RFP from RFP server 14 if the permissions for the supplier do not allow access to the RFP.

A supplier views an RFP received 1902 from a customer via RFP server 14 and displayed 1906 on output device 118 of the client device 34. A supplier also views any RFP documents attached to an RFP sent to the supplier and displayed 1910 on output device 118 of the client device 34.

Upon viewing an RFP and any RFP documents attached to the RFP, a supplier decides whether it is appropriate to accept the RFP. As an example, a supplier decides it is inappropriate to accept an RFP if the supplier has insufficient time to respond to the RFP. As another example, a supplier decides it is appropriate to accept an RFP if the supplier dislikes a customer that sent the RFP.

Upon receiving 1914 a decision from a supplier that it is inappropriate to respond to an RFP sent by a customer, a supplier, via input device 112 of client device 34, indicates to the processor of the client device to close 1918 the RFP. For example, when a supplier declines, via input device 112, a response preparation agreement, displayed on output device 118 of client device 34, to respond to an RFP, processor of the client device 34 receives a decision to not respond to the RFP and closes the RFP. A customer or an administrator prepares the response preparation agreement, via input device 112 of a client device, provides the agreement to RFP server 14 and the sever sends the agreement with an RFP to a supplier. In another embodiment, the response preparation agreement is not sent by the RFP server 14 with an RFP. Upon closure 1918 of an RFP, a customer that sent the RFP receives 1922, via client device 22, an email from the processor of client device 34 that the RFP has been closed and will not be responded to by a supplier who received the RFP.

On the other hand, upon receiving 1914 a decision from a supplier that it is appropriate to respond to an RFP sent by a customer, processor of client device 34 prompts 1926 a supplier, via output device 118 of the client device, to prepare an RFP response to an RFP received 1902 and the supplier prepares the response. For example, when a supplier accepts, via input device 112, the response preparation agreement, displayed on output device 118 of client device 34, to respond to an RFP, processor of the client device 34 prompts 1926 a supplier.

Upon receiving a prompt to prepare an RFP response, a supplier prepares the RFP response by inputting, via input device 112, to processor of client device 34, answers to questions sent within the RFP by a customer. As an example, a supplier prepares an RFP response by answering questions in a section that has the highest rank. As another example, a supplier prepares an RFP response by answering questions having the highest rank in a section. As yet another example, a supplier prepares an RFP response by answering a question regarding an availability of the supplier for implementation of a service or product at a supplier's business address. As still another example, a supplier prepares an RFP response by quoting a price of providing a product or a service to a customer that provided the RFP to the supplier.

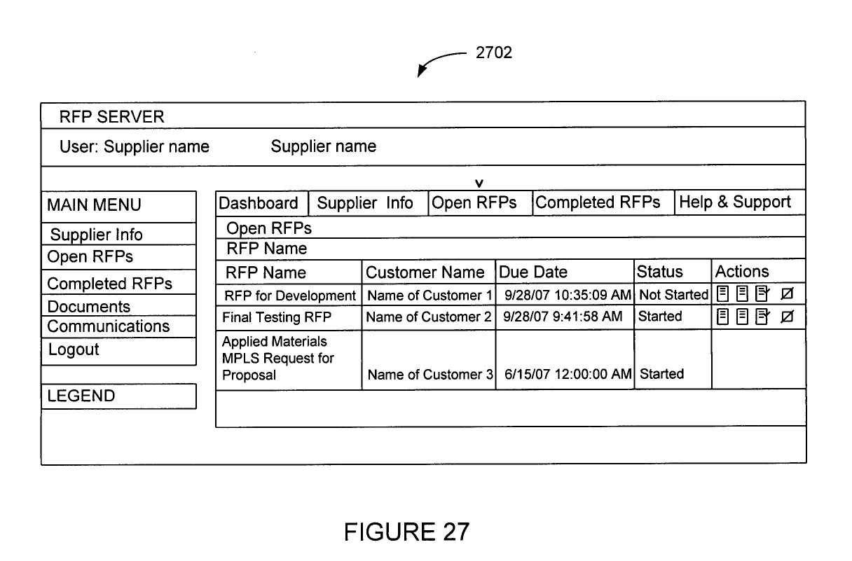

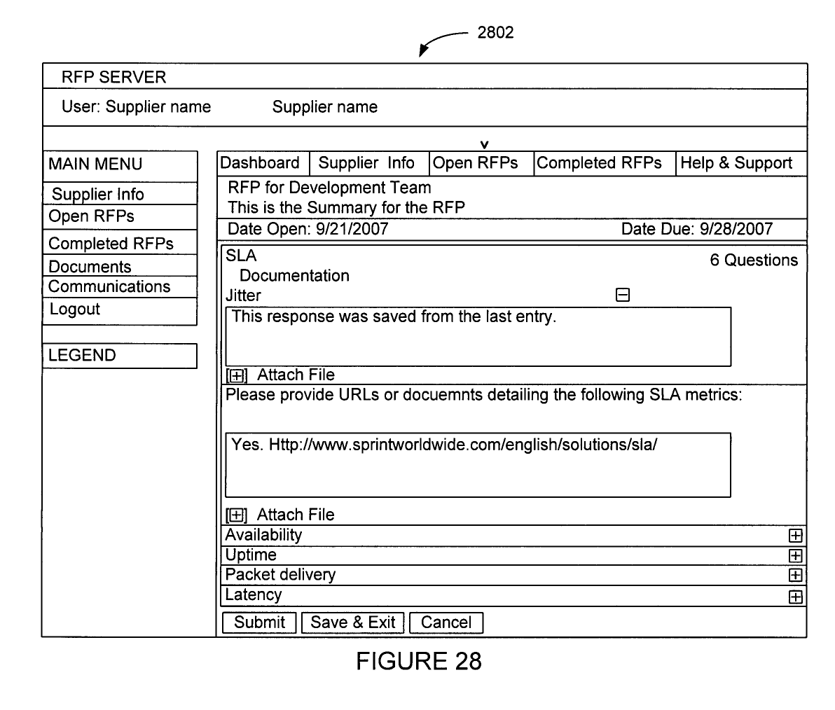

An exemplary web page 2702 with a list of RFPs accessed by a supplier, via input device 112 and processor of client device 34, from RFP server 14 is shown in FIG. 27. The list of RFPs, on web page 2702, shows a name of an RFP for which a supplier is preparing a response and also shows a name of an RFP for which the supplier has not started to prepare a response. Another exemplary web page 2802 showing preparation of an RFP response is shown in FIG. 28. A supplier enters, via input device 112 of client device 34, an answer to the jitter question and an answer to the SLA metrics question on web page 2802 accessed from RFP server 14 by processor of the client device to prepare an RFP response.

At any time during preparation of an RFP response, a supplier can desire to decline preparing the response. Upon desiring to decline preparation of an RFP response, a supplier, via input device 112 of client device 34, indicates to processor of the client device to close 1918 an RFP to which the supplier is responding. On the other hand, if a customer does not desire to decline preparation of an RFP response, the customer continues to prepare the response.

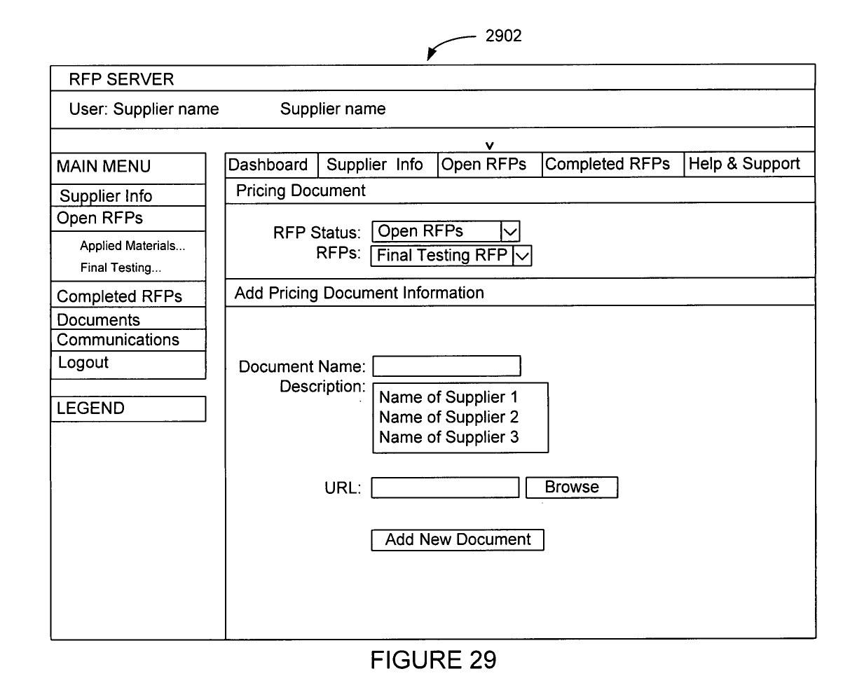

Moreover, at any time during preparation of an RFP response, a supplier attaches, via input device 112 of client device 34, an RFP response document within the RFP response. Examples of the RFP response document includes an initial pricing document and an email providing a timeline of implementing a product or service at a location of a customer. RFP server 14 stores any RFP response document within the database of the RFP server 14. The initial pricing document provides a quote for providing a service or a product to a customer that provided an RFP to a supplier. An exemplary web page 2902 providing an option to attach, within an RFP response, a URL of the initial pricing document, providing a dialog box to receive, within the RFP response, a name of the initial pricing document, and providing a dialog box to receive, within the RFP response, a description of the initial pricing document is shown in FIG. 29. The web page 2902 is accessed by a supplier from RFP server 14 via input device 112 of client device 34.

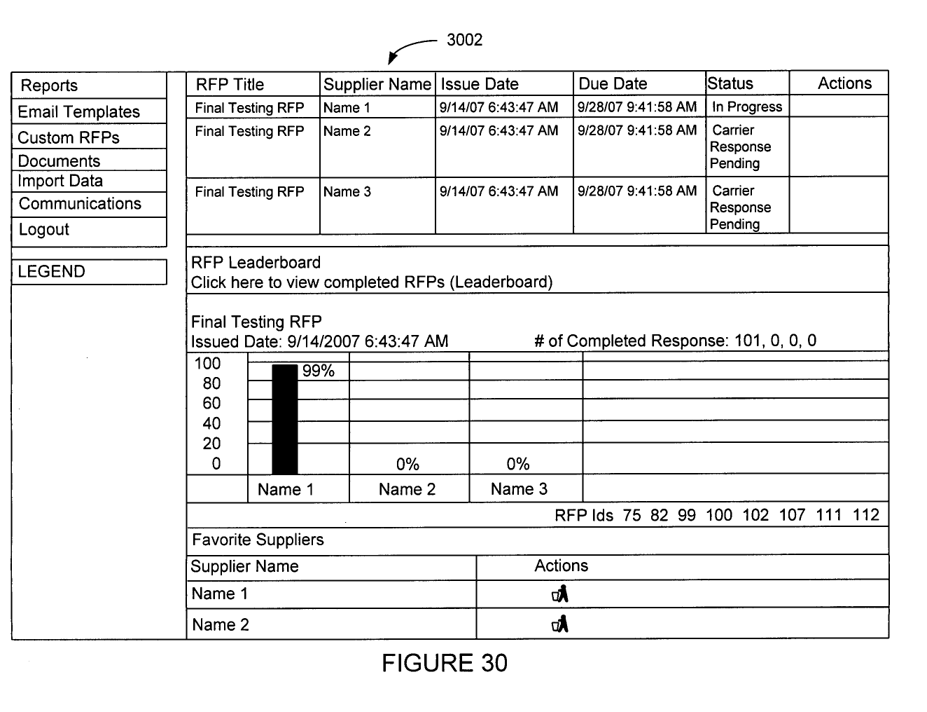

Moreover, at anytime during preparation of an RFP response, RFP server 14 generates an RFP leaderboard that displays progress made by a supplier on the RFP response. RFP server 14 generates the RFP leaderboard, which is accessed by a customer via input device 112 of client device 34. The RFP leaderboard displays whether a particular supplier has initiated preparation of an RFP response, whether the supplier has declined to prepare the response, and/or how close the supplier is to completion, described below, of the RFP report. As an example, RFP server 14 generates the RFP leaderboard showing a percentage of questions within an RFP answered by a supplier. For example, if 8 out of 10 questions within an RFP are answered by a supplier, RFP serve generates the RFP leaderboard showing that the supplier has finished 80% of an RFP response. As another example, if 6 out of 10 questions within an RFP are answered by a supplier, RFP server 14 generates the RFP leaderboard showing that the supplier has finished 60% of an RFP response. An exemplary RFP leaderboard web page 3002 is shown in FIG. 30. RFP leaderboard web page 3002 shows, as a bar graph, that Sprint™ Corporation, shown as “Name 1” has finished 99% of an RFP response and Verizon™ corporation, shown as “Name 2” has not started preparing a RFP response. A customer accesses the RFP leaderboard from the customer home page that is accessed by entering a login name and a password. In another embodiment, the RFP leaderboard shows a plurality of price quotes offered by a plurality of suppliers for providing a product or service in responding to an RFP.

In one embodiment, RFP server 14 provides an answer option to a supplier to select when the supplier decided that the supplier has finished answering a particular question within an RFP response. When a supplier selects the answer option, RFP server 14 determines that the supplier has finished answering a particular question within an RFP response. Until a supplier does not select the answer option, RFP server 14 determines that the supplier has not finished answering a particular question within an RFP response. When a supplier selects all answer options displayed within an RFP response, RFP server 14 determines that the supplier has prepared the RFP response. Otherwise, if at least one answer option within an RFP response is not selected by a supplier, RFP server 14 determines that the supplier has not prepared the response.

Upon preparing an RFP response and saving the response in memory device of client device 34, a supplier indicates, via input device 112 of the client device to processor of client device 22 that the RFP report is complete and the processor receives the indication that the RFP report is complete 1928. The RFP report, when completed 1928, may or may not include answers to all questions asked by a supplier to a customer in an RFP.

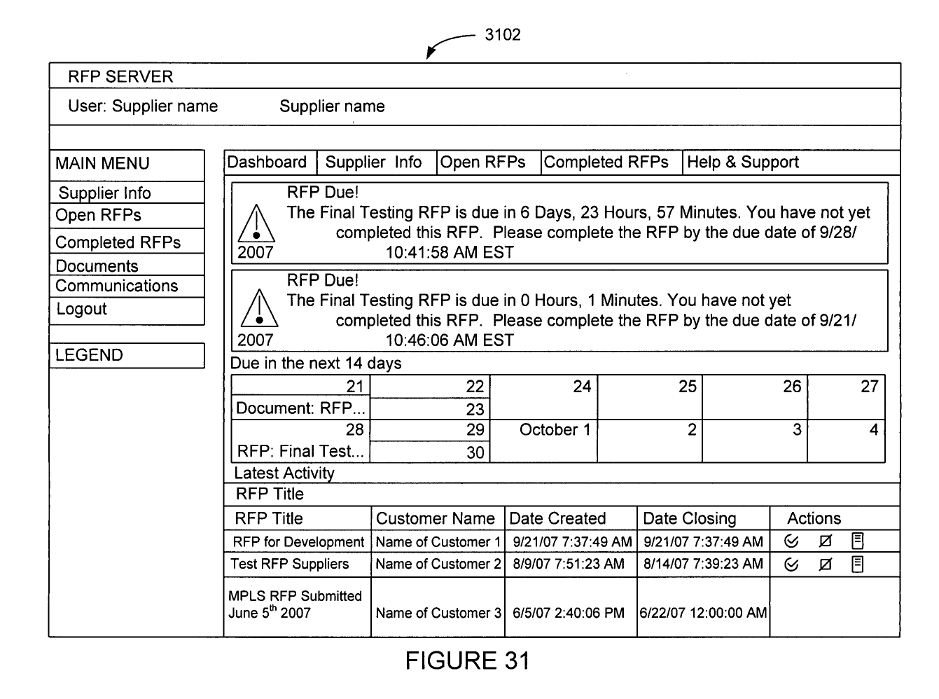

Upon receiving an indication from a customer that an RFP report is complete 1928 and a name of the RFP report, processor of client device 34 saves the RFP report within RFP server 14 and sends 1932 the RFP report to the database of memory device of client device 26 managed by an administrator. Examples of a name of the RFP report include report for Coherent™ and Sprint™, and report for Applied Materials™ and Sprint™. An exemplary web page 3102 with a due date, such as Sep. 28, 2007, for sending 1932 the RFP report and time remaining in completing the RFP report is shown in FIG. 31. Web page 3102 displays the due date within a calendar showing due dates for other RFP reports. Web page 3102 is accessed by processor of client device 34 from RFP server 14 upon receiving an input from a supplier. A customer uses input device 112 of client device 22 to provide a due date to client device 34 managed by a supplier, via the computer module and the RFP server 14, for sending 1932 the RFP report.

All communication related to an RFP and a RFP response between the supplier and the customer ends at a due time or due date for sending 1932 the RFP report. RFP server 14 does not allow any communication between a supplier and a customer related to an RFP or related to a RFP response upon determining that a due date or due time for sending 1932 the RFP report has ended. For example, RFP server 14 rejects any login name and passwords assigned by an administrator to a supplier for accessing the supplier home page upon determining that a due date or due time for sending 1932 the RFP report has passed and that the login name and passwords are received after the due date or due time. As another example, RFP server 14 rejects a login name and password assigned by an administrator to a customer for accessing the customer home page upon determining that a due date or due time for sending 1932 the RFP report has passed and that the login name and passwords are received after the due date or due time. In another embodiment, RFP server 14 does not place a time limit for allowing a communication between a supplier and a customer. In yet another embodiment, all communication related to an RFP and a RFP response between the supplier and the customer ends at a due time or due date for completing 1928 the RFP report. In one embodiment, RFP server 14 receives, from a customer, the same due date or due time for a plurality of suppliers for sending 1932 the RFP report that responds to an RFP provided by a customer. In another embodiment, RFP server 14 receives, from a customer, different due dates or different due times for a plurality of suppliers for sending 1932 the RFP report to respond to an RFP provided by the customer.

Upon receiving the RFP report sent 1932, processor of client device 26 managed by an administrator sends an email to client device 22 managed by a customer that the RFP report is sent to the customer. Upon receiving 2002 an email from an administrator that an RFP report is sent to a customer, processor of client device 22 receives a login name and a password from a customer to access the customer home page and upon receiving the login name and password, the processor provides access 2006 to the customer home page and the RFP report stored in RFP server 14. Upon receiving access to the RFP report, a customer reviews, via output device 108 of client device 22 managed by the customer, the RFP report. An RFP response is provided by a supplier to a customer when client device 22 managed by the customer receives the RFP report.

A customer, upon receiving the RFP report may accept or reject the RFP report. A customer can reject the RFP report by doing nothing further to receive a product or service mentioned in the RFP report and by letting the supplier know that the customer is disinterested in receiving the product or service from the supplier. On the other hand, a customer can accept the RFP report by agreeing to RFP responses to RFPs provided by a supplier and letting the supplier know of the agreement.

At any time between display 1906 of an RFP and sending 1932 the RFP report to an administrator, a supplier decides whether to send, from client device 34 via RFP server 14 a communication related to an RFP response to client device 22 managed by a customer requesting the response. For example, during preparation of an RFP response, a supplier decides to send a communication related to the response, via client device 34 and RFP server 14 to client device 22 managed by a customer requesting the response. As another example, between preparation of an RFP response and completing 1928 the RFP report, a supplier provides a decision to the processor of client device 34 to send a communication related to an RFP response, via RFP server 14, to client device 22 managed by a customer requesting the response. Upon receiving 2102 a decision to send a communication related to an RFP response, processor of client device 34 sends 2106 the communication to client device 22 managed by a customer and upon not receiving 2102 a decision to send the communication, the processor does not send 2110 the communication to the client device managed by the customer. Examples of a communication from a supplier to a customer related to an RFP response includes one or more initial queries, such as, is a substitute product or service acceptable to the customer instead of a product or service for which the RFP is requested, how much does the customer care about a color of a product on a scale of 1 thru 10, and is the customer flexible about its time requirements for implementing the product or service at the customer's business address.

Moreover, upon receiving at client device 22 a communication from a supplier related to an RFP response, a customer decides whether to send from the client device 22 via RFP server 14 a communication related to an RFP to client device 34 managed by the supplier. A communication related to an RFP response is received at client device 22 by using, including executing, the computing module. Examples of a communication related to an RFP sent from a customer to a supplier include one or more initial replies to the one or more initial queries. Examples of the initial replies include that a substitute product or service is not acceptable to a customer instead of a product or service for which an RFP is requested, that the customer cares about a color of a product on a scale of 4, and the customer is not flexible about its time requirements for implementing the product or service at the customer's business address. Upon receiving 2114 a decision from a customer to send a communication related to an RFP, processor of client device 22 managed by the customer sends 2118 the communication to client device 34 managed by a supplier that prepares an RFP response and upon not receiving 2114 a decision to send the communication, the processor of client device 22 does not send 2122 the communication to client device 34. A communication related to an RFP is received at client device 34 by using, including executing, the computing module.

Upon receiving the one or more initial replies related to an RFP from a customer, a supplier decides whether to send, via client device 34 and RFP server 14 to client device 22 a communication related to an RFP response and processor of client device 34 receives 2102 the decision. Examples of a communication related to an RFP response sent from a supplier to a customer include one or more additional queries that are or are not replies to the one or more initial replies. Examples of the one or more additional queries include whether a customer wishes to receive delivery of a product by ground service or air service and whether the customer has an office in California.

Upon receiving the one or more additional queries related to an RFP response, a customer, decides whether to send via client device 22 and RFP server 14 to client device 34 managed by the supplier, a communication related to an RFP and processor of the client device 22 receives 2114 the decision. Examples of a communication related to an RFP sent from a customer to a supplier include one or more additional replies to the one or more additional queries. Examples of the additional replies include a customer only wishes to receive delivery of a product via ground and a customer has an office in San Mateo, Calif. A supplier and a customer communicate with each other any number of times.

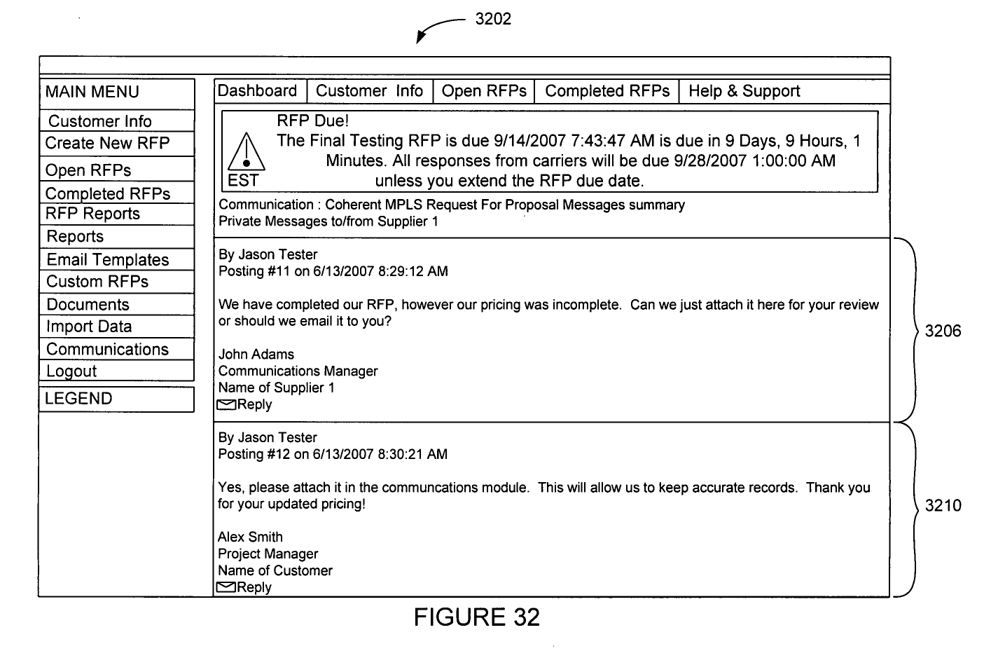

An exemplary web page 3202 showing a set of communications 3206, 3210, and 3214 between a supplier and a customer is shown in FIG. 32. Web page 3202 is accessed from RFP server 14 by any of client devices 18, 22, 26, 30, 34, and 38 having permission to access the web page. Communication 3206 is sent from client device 34 managed by a supplier to client device 22 managed by a customer, communication 3210 is sent from the client device 22 managed by the customer to client device 34 managed by the supplier, and communication 3214 is sent from client device 22 managed by the customer to client device 34 managed by the supplier. Communications 3206 and 3214 are related to an RFP response titled, “Final Testing RFP”, and communication 3210 is related to the RFP.

Another example web page 3302 shows communications 3210 and 3214 between a supplier and a customer, Web page 3302 is accessed from RFP server 14 by any of client devices 18, 22, 26, 30, 34, and 38 having permission to access the web page. An administrator managing client device 26 or 30 has permission to access any web page. A supplier or a customer accesses web page 3302 from RFP server 14 via input device 112 of corresponding client devices 18, 22, 34, and 38 to generate a communication in a comment box 3306 and to attach the RFP document to the communication. A supplier or a customer provides a communication to RFP server 14 by inputting the communication within comment box 3306 and selecting a make-comment option on web page 3302.

Upon receiving a communication related to an RFP from a customer, processor of client device 34 creates a link between the RFP and the communication. When a user with permissions or an administrator provides an indication to a processor of a client device that the user or the administration desires to search for a communication related to an RFP and enters a name or any other identification, such as a due date for sending 1932 the RFP report responding to the RFP, of the RFP, the processor accesses, from RFP server 14 the communication. On the other hand, when a user with permissions or an administrator provides an indication to a processor of a client device that the user or the administration desires to search for an RFP related to a communication and enters a portion of the communication, the processor accesses, from RFP server 14 the RFP.

Similarly, upon receiving a communication related to an RFP response from a customer, processor of client device 22 creates a link between the response and the communication. When a user with permissions or an administrator provides an indication to a processor of a client device that the user or the administration desires to search for a communication related to an RFP response and enters a name of the RFP report having the response or any other identification, such as a due date for sending 1932 the RFP report, of the response, the processor accesses, from RFP server 14 the communication. On the other hand, when a user with permissions or an administrator provides an indication to a processor of a client device that the user or the administration desires to search for a response related to a communication and enters a portion of the communication, the processor accesses, from RFP server 14 the RFP report having the response.

RFP server 14 generates an audit trail of a communication between a supplier and a customer. For example, RFP server 14 determines a time and a date a communication related to an RFP is sent from a customer to a supplier, and links and stores the time, the date, a name of the supplier, a name of the customer, and a name of the RFP within the database of the RFP server. As another example, RFP server 14 links a name of an RFP and a communication related to the RFP sent from a customer to a supplier, and stores the name, the communication, a name of the customer, and a name of the supplier within the database of the RFP server. As yet another example, RFP server 14 links a name of the RFP report with a communication related to an RFP response within the RFP report sent from a supplier to a customer and stores the name of the RFP report, a name of the customer, a name of the supplier, and the communication within the database of the RFP server.

When an administrator accesses RFP server 14 by entering a login name and a password, the administrator performs an audit trail. An administrator performs the audit trail by providing to RFP server 14, via input device 112 of client device 26, at least one of a name of an RFP and a name of the RFP report to access at least one of a communication related to the RFP and a communication related to an RFP response within the RFP report. For example, when an administrator provides a name of an RFP to RFP server 14, the server provides access to at least one of a communication related to the RFP to the administrator, a time of the communication, and a date of the communication, a name of a supplier sending the communication, and a name of a customer receiving the communication. As another example, when an administrator provides a name of a supplier and a name of an RFP to RFP server 14, the server provides access to the administrator to a communication that is related to the RFP and that is received by the supplier. As yet another example, when an administrator provides a name of a customer and a name of the RFP report to RFP server 14, the server provides access to the administrator to a communication that is related to an RFP response within the report and that is received by the customer.

Moreover, RFP server 14 stores all communication between a supplier and a customer within the database of the RFP sever. A communication between a supplier and a customer is in the form of plain text, hypertext markup language, formatted text and the communication may also include attached files.

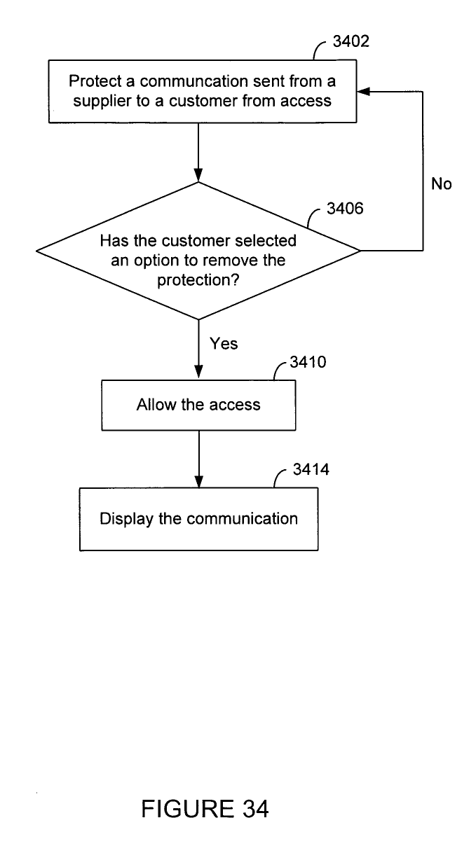

FIG. 34 is a flowchart of yet another embodiment of a method for generating and responding to an RFP. A communication sent by a supplier to a customer is protected 3402, by RFP server 14, from a response-communication access by a user other than the customer and the supplier sending the communication related to an RFP response. For example, RFP server 14 includes a firewall that does not allow access to a client device managed by a user other than a customer and other than a supplier sending the initial and additional queries to the customer to view the initial and additional queries. As another example, when a first supplier logs onto the supplier home page via input device 112 of client device 34, processor of the client device cannot access from RFP server 14 and cannot control output device 118 of the client device to display to the first supplier a communication related to an RFP response sent by a second supplier to a customer of the first supplier. A firewall is a part of the computing module.

RFP server 14 provides a response-communication option to a customer to remove a protection that reduces chances of the response-communication access or prevents the response communication access to a communication related to an RFP response to a user other than the customer and a supplier sending the communication. Client device 22 managed by a customer displays, via output device 108 of the client device, the response-communication option to a customer.

Upon displaying the response-communication option to a customer, processor of client device 22 determines 3406 whether the customer has decided to select the response-communication option and the selection allows the response-communication access from the RFP server 14 to a communication related to an RFP response to a user other than a supplier providing the RFP response to the customer. For example, upon viewing the response-communication option, a customer decides whether to select the response-communication option to allow the response-communication access from the RFP server 14 to a communication related to an RFP response to a designated supplier other than a supplier providing the RFP response to the customer. The designated supplier is selected, via input device 112 of client device 22, by a customer by selecting an identification parameter, such as a supplier name or a supplier email address. As another example, upon viewing the response-communication option, a customer decides whether to select the response-communication option to allow the response-communication access from the RFP server 14 to a communication related to an RFP response to one or more suppliers other than a supplier providing an RFP response to an RFP to the customer. In the example, the one or more other suppliers are also invited by the customer to provide RFP responses to the RFP. As yet another example, upon viewing the response-communication option, a first customer decides whether to select the response-communication option. In the example, the selection of the response-communication option allows the response-communication access from the RFP server 14. The response-communication access is an access to the RFP report sent to a second customer and to a communication related to an RFP response sent to the second customer other than the first customer. As another example, upon viewing the response-communication option, a customer decides whether to select the response-communication option to allow the response-communication access from the RFP server 14 to a communication related to an RFP response to an RFP to one or more suppliers other than a supplier providing the RFP response to the customer. In the example, the one or more other suppliers are also invited by the customer to provide RFP responses to the RFP.

Upon determining 3406 that the response-communication option is selected by a customer, RFP server 14 allows 3410 the response-communication access from the RFP server 14 by a client device managed by a user other than a user making the selection. In another embodiment, client device 34 managed by a supplier determines whether a supplier has selected the response-communication option displayed on the client device. Upon allowing 3410 the response-communication access, processor of client device 34 displays 3414, via output device 108, on the supplier home page, a communication related to an RFP response to a user other than at least one of a customer and a supplier sending the communication to the customer. As an example, upon allowing 3410 the response-communication access, processor of client device 34 displays 3414, via output device 108, on the supplier home page, a communication related to an RFP response to the pre-designated supplier other than at least one of a customer and a supplier sending the communication to the customer. On the other hand, upon determining 3406 that the response-communication option is not selected by a customer, RFP server 14 continues to protect 3402.

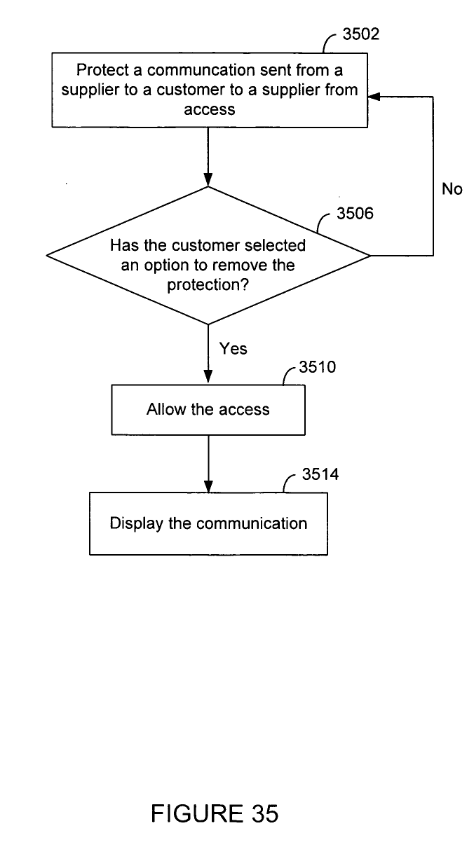

FIG. 35 is a flowchart of still another embodiment of a method for generating and responding to an RFP. A communication related to an RFP sent by a customer to a supplier is protected 3502, by RFP server 14, from an RFP-communication access by a user other the customer and the supplier receiving the communication. For example, RFP server 14 includes a firewall that does not allow access to a client device managed by a user other than a customer and other than a supplier receiving the initial and additional replies from the customer to view the initial and additional replies. As another example, when a first supplier logs onto the supplier home page, processor of client device 34 from RFP server 14 and does not display to the first supplier a communication related to an RFP received by a second supplier from a customer of the first supplier.

RFP server 14 provides an RFP-communication option to a customer to remove a protection that reduces chances of the RFP-communication access or prevents the RFP-communication access to a communication related to an RFP by a user other than the customer and a supplier receiving the communication. Client device 22 managed by a customer displays, via output device 108 of the client device, the RFP-communication option to a customer who decides whether to select the option to allow access from the RFP server 14 to a communication related to an RFP to one or more suppliers other than a supplier receiving the RFP from the customer. For example, upon viewing the RFP-communication option, a customer decides whether to select the RFP-communication option to allow the RFP-communication access from the RFP server 14 to a communication related to an RFP to a pre-selected supplier other than a supplier receiving the RFP from the customer. The pre-selected supplier is selected, via input device 112 of client device 22, by a customer by selecting an identification, such as a supplier name or a supplier email address. As another example, upon viewing the RFP-communication option, a customer decides whether to select the RFP-communication option to allow the RFP-communication access from the RFP server 14 to a communication related to an RFP to one or more suppliers other than a supplier providing an REF response to an RFP to the customer. In the example, the one or more other suppliers are also invited by the customer to provide RFP responses to the RFP.

Upon determining 3506 that the RFP-communication option is selected by the customer, RFP server 14 allows 3510 the RFP-communication access from the RFP server 14 by a client device managed by a user other than a user making the selection. In another embodiment, client device 34 managed by a supplier receives the selection 3506 of the RFP-communication option displayed on the client device. Upon allowing 3510 the RFP-communication access, processor of client device 34 displays 3514, via output device 108, on the supplier home page, a communication related to an RFP to a user other than at least one of a supplier and a customer sending the communication to the supplier. As an example, upon allowing 3510 the RFP-communication access, processor of client device 34 displays 3514, via output device 108, on the supplier home page, a communication related to an RFP to the pre-selected supplier other than at least one of a supplier and a customer sending the communication to the supplier. On the other hand, upon determining 3506 that the response-communication option is not selected by a customer, RFP server 14 continues to protect 3502.

An administrator can access from RFP server 14 and views all communication between a supplier and a customer made via client device 22, RFP server 14, and client device 34. For example, output device 108 of client device displays one or more of the initial queries, one or more of the initial replies, one or more of the additional queries, and one or more of the additional replies to an administrator administering the computing module. Moreover, an administrator can access the RFP report from RFP server 14 and view the RFP report on client device managed by the administrator. For example, output device 108 of client device displays the RFP report on client device managed by an administrator.

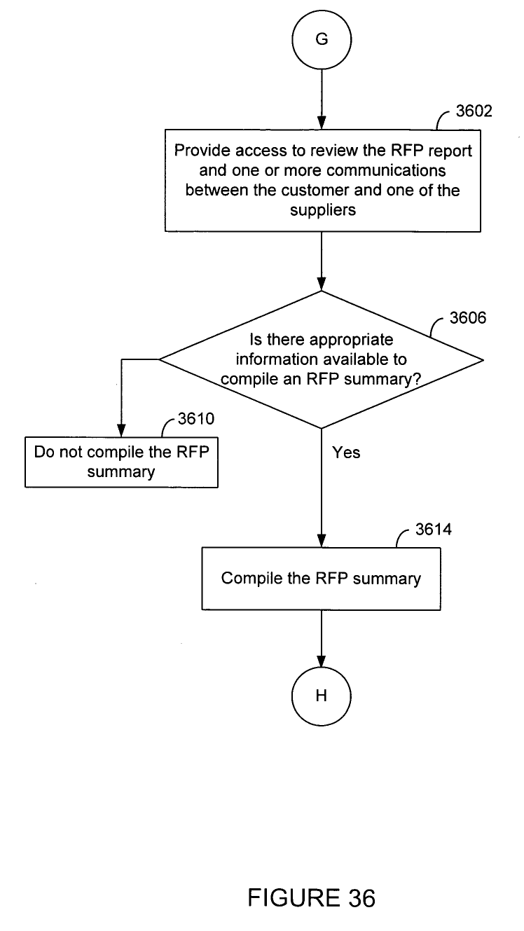

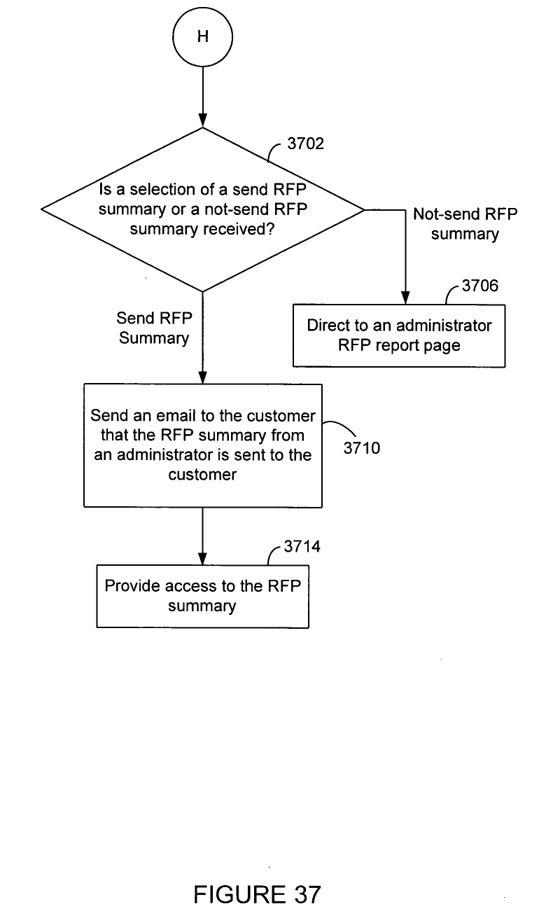

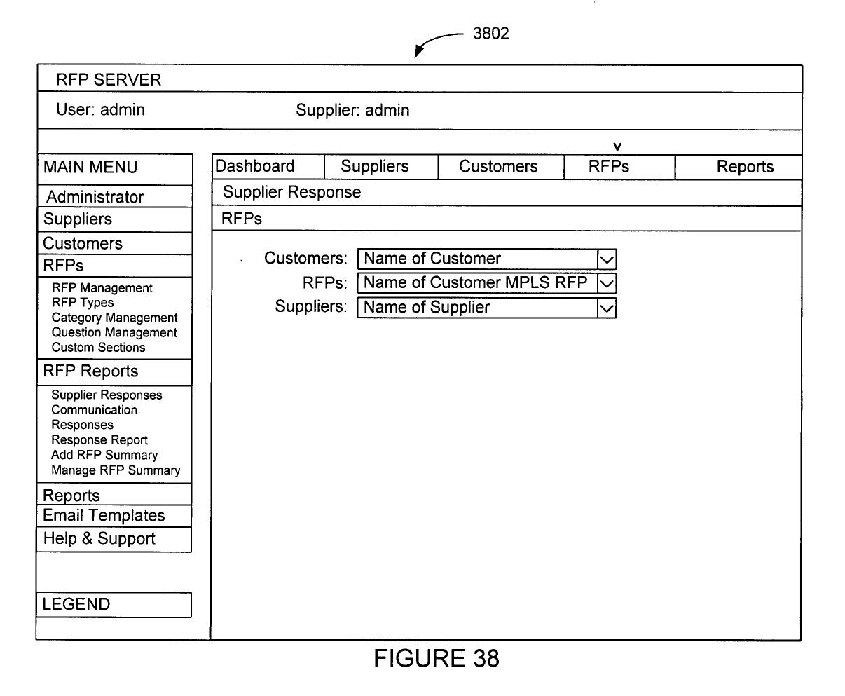

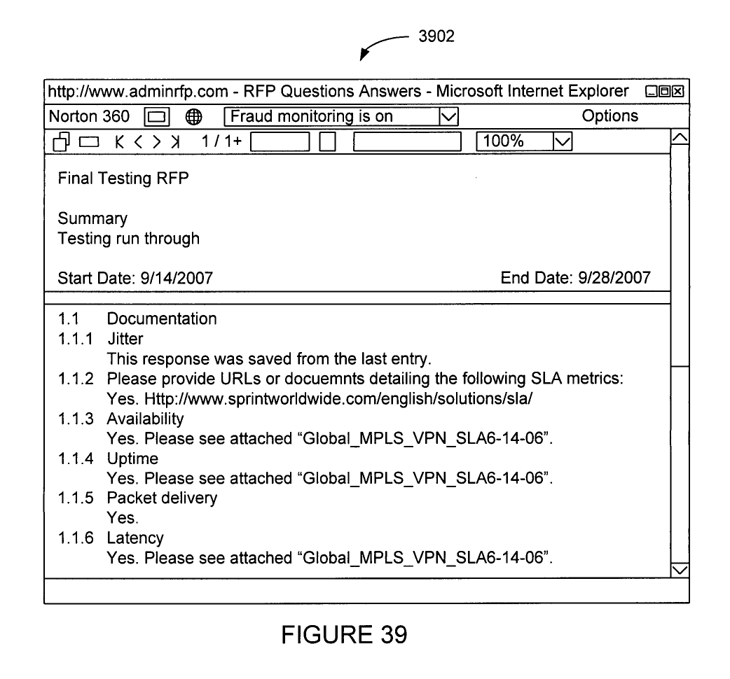

FIGS. 36 and 37 are a flowchart and FIGS. 38, 39, 40, and 41 are web pages of another embodiment of a method for generating and responding to an RFP. Upon receiving a login name and a password from an administrator, processor of client device 30 provides access 3602 to the administrator to review the RFP report and to review any communication between a customer preparing an RFP and a supplier preparing an RFP response to the RFP within the RFP report. For example, an administrator logs in to gain access to RFP server 14 and accesses a web page 3802, shown in FIG. 38, from the RFP server 14. An administrator selects, via input device 112 of client device 26, from a drop down menu on web page 3802, a particular supplier, a particular customer, and an RFP within the RFP report to access, from RFP server 14, the RFP report and any communication, between a supplier and a customer, related to the RFP provided by the customer and related to an RFP response provided by the supplier to the RFP.

The RFP report and any communication, between a supplier and a customer, related to the RFP provided by the customer and related to a response provided by the supplier to the RFP are displayed on an administrator RFP report page accessed from RFP server 14 by client device 26 managed by the administrator. An exemplary web page 3902 shows an example of a portion of the RFP report that an administrator accesses from RFP server 14 via input device 112 of client device 26. The administrator RFP report page, the supplier administration web page, the customer administration web page, and any other web page generated by executing the computer module are accessed by an administrator from RFP server 14 via client device 26 by providing a user name and a password to the RFP server 14.

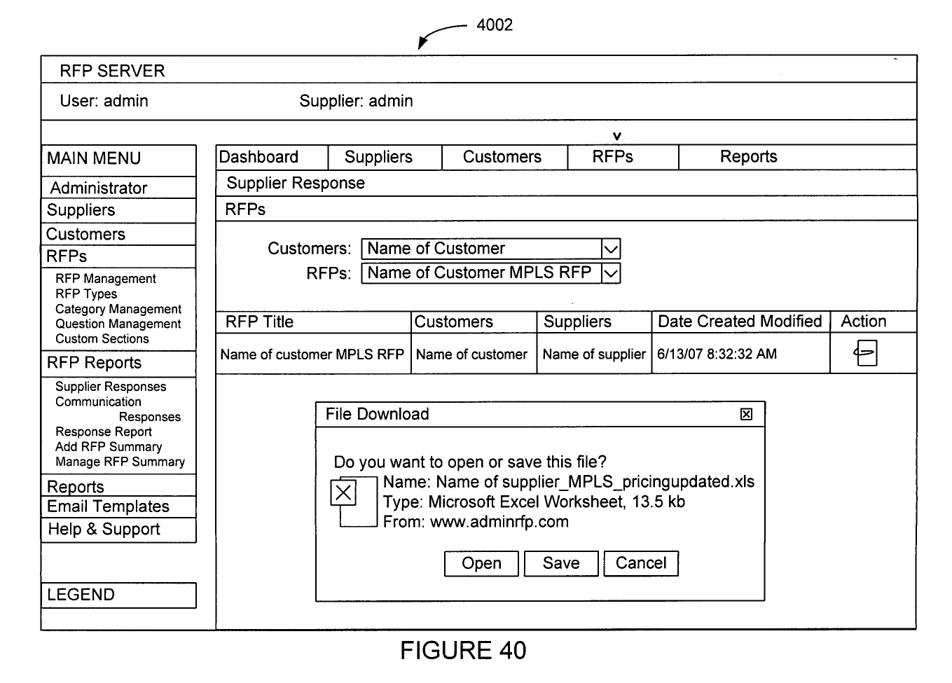

The processor of client device 26 managed by an administrator provides a finish-review option to the administrator on the administrator RFP report page for each RFP report and any communication related to an RFP within the RFP report and an RFP response within the RFP report. Upon reviewing the RFP report and any communication, such as communication related to an RFP or communication related to an RFP response within the RFP report, between a supplier and a customer, an administrator selects the finish review option on output device 108 of client device 26 indicating to RFP sever 14 that the administrator has finished reviewing the RFP report and the communication. During the review of the RFP report and any communication between a supplier and a customer, an administrator may change an RFP within the RFP report, a RFP response within the RFP report, or the communication related to the RFP provided by the customer or related to a response provided by the supplier to the RFP. For example, as shown on a web page 4002, in FIG. 40, an administrator may upload to RFP server 14, via input device 112 of client device 26, an updated pricing document within an RFP response including the initial pricing document to replace the initial pricing document within the updated pricing document. An administrator uploads, via web page 4002 to RFP server 14, the updated pricing document named “Name of supplier_mpls_pricing_updated.xls” within an RFP response titled “Name of customer MPLS RFP”.

Upon receiving a selection of the finish review option, the processor of client device 26 saves any changes made to the RFP report and any communication, such as communication related to an RFP within the RFP report and communication related to a response within the RFP report, and prompts 3606, via output device 108 of the client device 26, an administrator to decide whether it is appropriate to compile an RFP summary, which is a report. The processor of client device 26 prompts 3606, via output device 108, an administrator to decide whether it appropriate to compile the RFP summary by displaying two options including an appropriateness option and an inappropriateness option on output device 108 to the administrator. The appropriateness option states that it is appropriate to compile the RFP summary and the inappropriateness option states that it is inappropriate to compile the RFP summary.

Upon deciding that it is inappropriate to compile the RFP summary from the RFP report and a communication between a supplier and a customer, an administrator does not choose to compile the RFP summary and selects the inappropriateness option. As an example, an administrator decides that it is inappropriate to compile the RFP summary if the RFP report includes a majority, such as 6 out of 10 or 7 out of 10, of queries that are not replied to. As another example, an administrator decides that it is inappropriate to compile the RFP summary if the RFP report includes incomplete sentences or sentences that cannot be comprehended by the administrator. Upon receiving the selection of the inappropriateness option, processor of client device 26 does not compile 3610 the RFP summary.

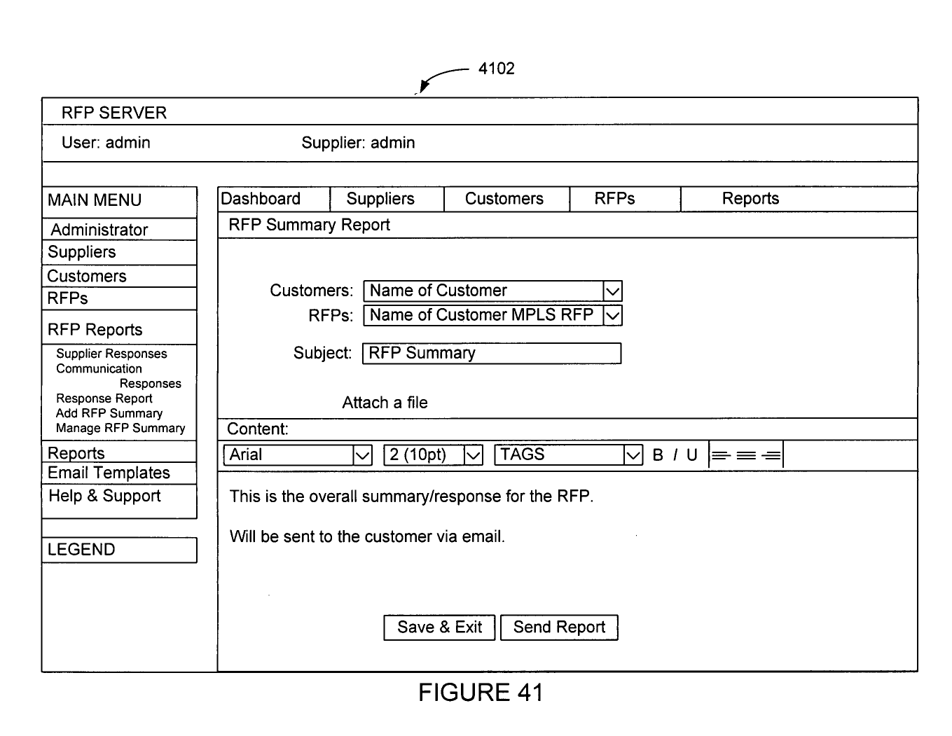

On the other hand, upon deciding that it is appropriate to compile the RFP summary, an administrator selects, via input device 112 of client device 26, the appropriateness option. Upon selection of the appropriateness option, processor of client device 26 managed by an administrator compiles 3614 the RFP summary to include, within the RFP summary, the RFP report and any communication between a supplier and a customer related to an RFP within the RFP report and related to an RFP response to the RFP. As an example, an administrator decides that it is appropriate to compile the RFP summary if the RFP report includes a majority, such as 6 out of 10 or 7 out of 10, of queries that are replied to. As another example, an administrator decides that it is appropriate to compile the RFP summary if the RFP report includes sentences that are understood by the administrator. In one embodiment, the RFP summary includes a message, such as an email or an electronic facsimile, from an administrator to send to a customer. In another embodiment, the RFP summary includes at least one of an RFP, an RFP response to the RFP, an RFP document describing a product or service for which the RFP is prepared, and an RFP response document responding to the RFP. An example of the RFP summary is shown on a web page 4102 in FIG. 41. The RFP summary on web page 4102 includes an email from an administrator to a customer.

In another embodiment, upon selection of the appropriateness option, processor of client device 26 managed by an administrator compiles the RFP summary to include, within the RFP summary, an RFP within the RFP report or an RFP response to the RFP and to include, within the RFP summary, at least one communication related to the RFP or at least one communication related to the response. For example, upon selection of the appropriateness option, processor of client device 26 managed by an administrator compiles the RFP summary to include, within the RFP summary, an RFP within the RFP report and a communication related to the RFP. As another example, upon selection of the appropriateness option, processor of client device 26 managed by an administrator compiles 3614 the RFP summary to include, within the RFP summary, an RFP response within the RFP report and a communication related to the response.

Upon compiling 3614 the RFP summary, processor of client device 26 displays, on output device 108 of the client device, a send RFP summary option to an administrator and a not-send RFP summary option to the administrator. An administrator decides whether to send the RFP summary to a customer who prepared an RFP within the RFP summary. As an example, an administrator decides not to send the RFP summary to a customer if the customer has indicated, via an email, to the administrator that the customer does not want or need the RFP summary. As another example, an administrator decides to send the RFP summary to a customer if the customer has not indicated, to the administrator that the customer does not want or need the RFP summary.

Upon deciding not to send the RFP summary to a customer that prepared an RFP within the R′FP summary, an administrator selects the not send RFP summary option. Upon receiving 3702 the selection of the not send RFP summary option, processor of client device 26 does not send the RFP summary to a customer who prepared an RFP within the RFP summary and directs 3706 the administrator to the administrator RFP report page by displaying the administrator RFP report page on output device 108 of the client device.

On the other hand, upon deciding to send the RFP summary to a customer who prepared an RFP within the RFP summary, an administrator selects the send RFP summary option. Upon receiving 3702 the selection of the send RFP summary option, processor of client device 26 sends the RFP summary to a customer who prepared an RFP within the RFP summary and directs 3706 the administrator to the administrator RFP report page by displaying the administrator RFP report page on output device 108. Moreover, upon receiving the selection of the send RFP summary option from an administrator, processor of client device 26 also sends 3710 an email to a customer who prepared an RFP within the RFP summary and the email states that the RFP summary is provided by an administrator to the customer. Upon receiving the email stating that the RFP summary is provided by an administrator to a customer, the customer logs onto the customer home page and upon receiving a login name and a password from the customer, processor of client device 22 provides access 3714, from RFP server 14, to the RFP summary and displays, on output device 118 of client device 22, the RFP summary.

It is noted that RFP server 14 stores any portion of an RFP, any portion of an RFP response to the RFP, any portion of the RFP report including the RFP and the RFP response, and any portion of the RFP summary within the database of the memory device of RFP server 14. In one embodiment, a customer can access, via input device 112 of client device 22, a first RFP, modify any questions within the first RFP to create a second RFP, and saves the second RFP within RFP server 14. For example, a customer accesses from RFP server 14, the first RFP sent from the customer to the first supplier, adds two questions or modifies or deletes two of existing ten questions within the first RFP, saves the modified first RFP as the second RFP within RFP server 14, and sends from client device 22 the second RFP to client device 34 managed by the second supplier. In the example, the customer accesses the RFP server 14 by providing, via input device 112, a command, which is an instruction to processor of client device 22 to access the first RFP from RFP server 14.

In another embodiment, a supplier can access a first RFP response, modify any answers within the first RFP response to create a second RFP response, and saves the second RFP response within RFP server 14. For example, a supplier accesses, via input device 112 of client device 34, from RFP server 14, the first RFP response from the supplier to the first customer, adds two answers or modifies or deletes two of existing ten answers within the first RFP response, saves the modified first RFP response as the second RFP response within RFP server 14, and sends from client device 34 the second RFP response to client device 22 managed by the second customer. In the example, the supplier accesses the RFP server 14 by providing, via input device 112, a command to processor of client device 34 to access the first RFP response from RFP server 14.

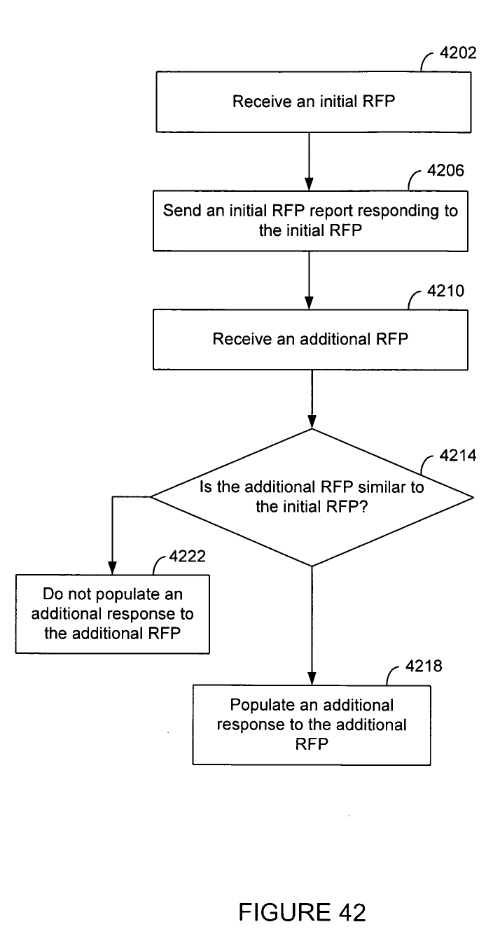

FIG. 42 is a flowchart of an embodiment of a method for generating an RFP and responding to the RFP. Processor of client device 34 receives 4202 an initial RFP from client device 22 via RFP server 14 and stores the initial RFP within a memory device of the client device and/or RFP server 14. In the method, reception 4202 of the initial RFP is the same as receiving 1902 an RFP. An example of storing the initial RFP is provided in 1700. Another example of storing the initial RFP is provided in 1814.

Processor of client device 34 receives 4202 the initial RFP and upon receiving an indication from a supplier that an initial RFP report including an initial response to the initial RFP is complete, sends 4206 the initial RFP report to client device 34. An example of receiving an indication that the initial RFP report is complete is provided in 1928. An example of sending the initial RFP report is provided in 1932.

In one embodiment, instead of sending 4206 the initial RFP report to client device 34 managed by a supplier, RFP server 14 provides access to an initial RFP summary to the client device. An example of providing access to the initial RFP summary is provided in 3714 is provided in 1928. The initial RFP summary is compiled in the same manner as that of the compilation described in 3614.

Further, processor of client device 34 receives 4210 an additional RFP from client device 22 via RFP server 14 and stores the additional RFP within a memory device of the client device and/or RFP server 14. In the method, reception 4210 of the additional RFP is the same as receiving 1902 an RFP. An example of storing the additional RFP is provided in 1700. Another example of storing the additional RFP is provided in 1814.

Processor of client device 34 receives 4210 the additional RFP, and determines 4214 whether the additional RFP is similar to the initial RFP and whether the additional RFP and the initial RFP are received by the same supplier. As an example, processor of client device 34 determines that the additional RFP is similar to the initial RFP upon determining that at least one question within the additional RFP is the same as at least one question within the initial RFP. As another example, processor of client device 34 determines that the additional RFP is similar to the initial RFP upon determining that a majority of questions within the initial RFP are the same as a majority of questions within the additional RFP. As another example, processor of client device 34 determines that the additional RFP is similar to the initial RFP upon determining that a majority of questions within the additional RFP are the same as questions within the initial RFP. As yet another example, processor of client device 34 determines that the additional RFP is similar to the initial RFP upon determining that a majority of questions within the initial RFP are the same as questions within the additional RFP. As another example, processor of client device determines 4214 that the additional RFP is not similar to the initial RFP upon determining that the majority of questions within the initial RFP are not the same as questions within the additional RFP. As yet another example, processor of client device 34 determines that the additional RFP is not similar to the initial RFP upon determining that at least one question within the initial RFP does not match at least one question within the additional RFP. As another example, processor of client device 34 determines that the additional RFP and the initial RFP are received by the same supplier upon determining that a supplier with a unique supplier login identification accesses the additional RFP and the initial RFP. As another example, processor of client device 34 determines that the additional RFP and the initial RFP are received by the same supplier upon determining that a supplier with a unique email address accesses the additional RFP and the initial RFP.

The initial RFP is an RFP within the initial RFP report or the initial RFP summary. Moreover, the initial response is a response to the initial RFP and is located within the initial RFP report of the initial RFP summary. Upon determining that the initial response is changed by an administrator to create a changed RFP response, processor of RFP server 14 does not provide access to a client device to the initial response and provides access to the changed RFP response. Similarly, upon determining that that the initial RFP within the initial RFP report is changed by an administrator to create a changed RFP processor of RFP server 14 does not provide access to a client device to the initial RFP and provides access to the changed RFP.

Upon determining that the initial and the additional RFPs are similar to each other and determining that the initial and additional RFPs are received by the same supplier, processor of client system 34 populates 4218 an additional RFP response to the additional RFP with an answer to a question that is the same as a question within the initial RFP. For example, upon determining that a first question within the initial RFP and a second question within the additional RFP are the same and determining that the initial and additional RFPs are received by the same supplier, processor of client device 34 provides an answer to the second question and the answer is the same as an answer to the first question. As another example, upon determining that six out of ten questions within the initial RFP are the same as six out of ten questions within the additional RFP and determining that the initial and additional RFPs are received by the same supplier, processor of client device 34 copies answers to the six questions within the initial RFP as answers to the six questions within the additional RFP. Upon populating 4218, processor of client device 34 provides an option to a supplier to edit any answers within the additional RFP. On the other hand, upon determining that the initial and the additional RFPs are not similar to each other or upon determining that the initial and additional RFPs are received by different suppliers, processor of client system 34 does not populate 4222 the additional RFP response with answers to questions that are the same as questions within the initial RFP and prompts 1926 a supplier, via output device 118 of the client device, to prepare an RFP response to questions within the additional RFP.

In another embodiment, upon determining that the initial and the additional RFPs are similar to each other, processor of client system 34 populates an additional RFP response to the additional RFP with an answer to a question that is the same as a question within the initial RFP. For example, upon determining that a first question within the initial RFP and a second question within the additional RFP are the same, processor of client device 34 provides an answer to the second question and the answer is the same as an answer to the first question. On the other hand, upon determining that the initial and the additional RFPs are not similar to each other, processor of client system 34 does not populate 4222 the additional RFP response to the additional RFP with answers to questions that are the same as questions within the initial RFP and prompts 1926 a supplier, via output device 118 of the client device, to prepare an RFP response to questions within the additional RFP.

In yet another embodiment, RFP server 14 creates a help section to answer any question posed by a customer or a supplier. Upon receiving a selection of a help icon from a user, RFP server 14 determines a section that the user is using. Upon determining that a customer selected the help icon while providing an answer within the network section, RFP server 14 generates one or more help problems and one or more solutions to the problems. The help problems and the solutions are related to a section that a user is using within an RFP or an RFP response. For example, upon receiving a selection of a help icon while a supplier is responding to a question within the network section, RFP server 14 generates a help problem, such as, what is a network, and generates a help solution, such as, a network is a set of computers connected to each other, to the problem. As another example, upon receiving a selection of a help icon while a customer is editing a question within the support section, RFP server 14 generates a help problem, such as, what is support, and generates a help solution, such as, support is technical support provided to a customer when a network is nonfunctional, to the problem.

A user views a help problem and a help solution related to a section within an RFP or an RFP response and decides whether the help solution provides a solution that the user desires. If a help solution does not provide a solution desired by a user, the user enters, via input device 112 of a client device, another help problem. RFP server 14 receives the other help problem and sends the other help problem to an administrator. An administrator provides a help solution to the other help problem and uploads, via input device 112 of client device 26, the help solution to RFP server 14. Upon receiving a help solution to the other help problem, RFP server 14 links the solution within a section related to the other help problem. A user having the other help problem accesses, from RFP server 14, a solution that solves the other help problem and that is uploaded by an administrator to the server. RFP server 14 provides access to a solution to the other help problem related to a section when a user selects the help icon while preparing a question within the section or responding to an answer within the section of an RFP.

In one embodiment, the processor of client device 26 maps a price of a product or a service within a pricing document, such as the initial or the updated pricing document, with the product or the service to create an item mapping and saves the item mapping in memory device of RFP server 14. Moreover, in another embodiment, the processor of client device 26 maps a price of a product or a service within a pricing document, such as the initial or the updated pricing document, with an industry of the product or the service to create an industry mapping and saves the industry mapping in memory device of RFP server 14. Examples of a product within an industry include a tire within the motor vehicle industry, a Dell™ Inspiron™ 531 desktop, Broadcom™ corporation's BCM5365/5365P Sentry5™ secured switch processor, a router within the telecommunications network equipment industry, and a gaming machine within the gaming industry. Examples of a service within an industry include prosecution of a patent application within a legal services industry and preparing a balance sheet within an accounting services industry.

A user or an administrator can access the item mapping and/or the industry mapping, via input device 112 of client device 26 and RFP server 14, to view a historical price of a product or service within a particular industry or across a variety of industries. For example, an administrator searches, within RFP server 14, a price of a Dell™ Inspiron™ 531 desktop, and the administrator accesses, from the RFP server 14, via input device 112, a list of prices of the desktop within one or more RFP reports or one or more RFP summaries, and displays the prices, the one or more RFP reports, or the one or more RFP summaries to the administrator. As another example, an administrator searches, within the database of RFP server 14, a price of all perfumes within a fragrance industry, and the administrator accesses, from the RFP server 14, via input device 112, a list of prices of the perfumes within one or more RFP reports or one or more RFP summaries and displays the prices, the one or more RFP reports, or the one or more RFP summaries to the administrator.

In another embodiment, RFP server 14 creates a variety of pre-defined reports. For example, RFP server 14 obtains a certain number of RFP summaries including RFPs sent by a customer to a set of suppliers and stored within the database of RFP server 14. In the example, after obtaining the number of RFP summaries and upon receiving a selection from an administrator or a user with permissions to create a list of the suppliers, the customer, and the RFPs, RFP server 14 creates one of the pre-defined reports including the list of the suppliers in one column, the customer in another column, and the RFPs in yet another column. As another example, RFP server 14 obtains the number of RFP summaries including RFPs sent by a customer to a set of suppliers and stored within the database of RFP server 14. In the example, after obtaining the number of RFP summaries and upon receiving a selection from an administrator or a user with permissions to create a list of the suppliers, the customer, a number of employees working for the customer, and the RFPs, RFP server 14 creates one of the pre-defined reports including a list of the suppliers in one column, the customer in another column, a number of employees working for the customer in yet another column, and the RFPs in still another column.

As yet another example, RFP server 14 obtains a certain number of RFP summaries including RFP responses that are requested by a plurality of customers from a supplier and that are stored within the database of RFP server 14. In the example, after obtaining the number of RFP summaries and upon receiving a selection from an administrator or a user with permissions to create a list of the customers requesting the RFP responses, the supplier providing the RFP responses to a set of RFPs, and the RFPs or the RFP responses, RFP server 14 creates one of the pre-defined reports including a list of the customers in one column, the supplier in another column, and the RFPs or the RFP responses in yet another column.

As another example, RFP server 14 obtains a certain number of RFP summaries including RFPs sent by a customer to a set of suppliers and stored within the database of RFP server 14. In the example, after obtaining the number of RFP summaries and upon receiving a selection from an administrator or a user with permissions to create a list of the RFPs stored within the database within a certain time or date range, RFP server 14 creates one of the pre-defined reports including a list of the RFPs, a list of the customer that prepared the RFPs, and/or a list of the suppliers invited to respond to the RFPs. As yet another example, RFP server 14 obtains a certain number of RFP summaries including RFPs sent by a customer to a set of suppliers and stored within the database of RFP server 14. In the example, after obtaining the number of RFP summaries and upon receiving a selection from an administrator or a user with permissions to create a list of the RFPs that are not closed, RFP server 14 creates one of the pre-defined reports including a list of the RFPs that are not closed, a list including the customer that prepared the RFPs, and/or a list of suppliers invited to respond to the RFPs.

For example, RFP server 14 obtains a certain number of RFP summaries including RFPs sent by a customer to a set of suppliers and stored within the database of RFP server 14. In the example, after obtaining the number of RFP summaries and upon receiving a selection from an administrator or a user with permissions to create a list of prices proposed by a plurality of suppliers for providing a product or service to a customer, RFP server 14 creates one of the pre-defined reports including a list of the prices, a list showing the customer, and a list of the suppliers invited by the customer to provide the prices. An administrator or a user with permission accesses RFP server 14 via input device 112 of client device 26 to access any of the pre-defined reports and the pre-defined reports are displayed on output device 118 of client device 26.

In yet another embodiment, RFP server 14 receives from a customer, via input device 112 of client device 34, one or more favorite suppliers of the customer. For example, a customer designates, via input device 112 of client device 22, one or more suppliers as favorite suppliers of the customer. Upon receiving, in 1630 or 1810, a selection from a customer of one or more names of one or more suppliers for sending an RFP, RFP server 14 selects names of the favorite suppliers of the customer and provides an option to the customer to de-select the favorite suppliers. At least one of the favorite suppliers selected by RFP server 14 is different than at least one supplier whose selection is received, in 1630 or 1810, from a customer. In another embodiment, the favorite suppliers selected by RFP server 14 are the same as suppliers whose selection is received, in 1630 or 1810, from a customer. Any suppliers that are selected either by a customer or RFP server 14 receive an RFP, such as in 1902, and are invited by the customer to prepare an RFP response to the RFP.

In another embodiment, upon receiving, in 1630 or 1810, a selection from a customer of one or more names of one or more suppliers for sending an RFP, RFP server 14 selects names of the favorite suppliers of the customer and provides an option to the customer to de-select the favorite suppliers. In this embodiment, the favorite suppliers selected by RFP server 14 are within the same industry as that of suppliers whose selection is received, in 1630 or 1810, from a customer and RFP server 14 does not select the remaining of the favorite suppliers who are not within the same industry as that of suppliers whose selection is received, in 1630 or 1810.

In yet another embodiment, upon receiving, in 1630 or 1810, a selection from a customer of one or more names of one or more suppliers for sending an RFP, RFP server 14 selects names of the favorite suppliers of the customer and provides an option to the customer to de-select the favorite suppliers. In this embodiment, the favorite suppliers selected by RFP server 14 provide the same product or service as that of suppliers whose selection is received, in 1630 or 1810, from a customer and RFP server 14 does not select the remaining of the favorite suppliers who do not provide the same product or service as that of suppliers whose selection is received, in 1630 or 1810. As an example, products that are the same as each other are manufactured by the same company and have the same model number. As another example, products that are the same as each other are manufactured by the different companies and have the same technical specifications, such as, size and weight. As another example, preparation of a patent application is the same service offered by a law firm as preparation of a patent application by another law firm. As yet another example, preparation of a balance sheet is the same service offered by an accounting firm as preparation of a balance sheet offered by another accounting firm.

It is noted that processes executed in 302, 306, 310, 314, 318, 322, 402, 406, 410, 414, 418, 422, 426, 902, 906, 910, 914, 918, 922, 1002, 1004, 1008, 1012, 1016, 1020, 1024, 1602, 1606, 1610, 1614, 1618, 1622, 1626, 1630, 1700, 1702, 1706, 1710, 1714, 1718, 1722, 1726, 1802, 1806, 1810, 1814, 1902, 1906, 1910, 1914, 1918, 1922, 1926, 1928, 1932, 2002, 2006, 2102, 2106, 2110, 2114, 2118, 2122, 3402, 3406, 3410, 3414, 3502, 3506, 3510, 3514, 3602, 3606, 3610, 3614, 3702, 3706, 3710, 3714, 4202, 4206, 4210, 4214, 4218, 4222, and any other processes described as performed by a processor are executed by executing the computing module. Moreover, it is noted that in one embodiment, all of processes executed in 302, 306, 310, 314, 318, 322, 402, 406, 410, 414, 418, 422, 426, 902, 906, 910, 914, 918, 922, 1002, 1004, 1008, 1012, 1016, 1020, 1024, 1602, 1606, 1610, 1614, 1618, 1622, 1626, 1630, 1700, 1702, 1706, 1710, 1714, 1718, 1722, 1726, 1802, 1806, 1810, 1814, 1902, 1906, 1910, 1914, 1918, 1922, 1926, 1928, 1932, 2002, 2006, 2102, 2106, 2110, 2114, 2118, 2122, 3402, 3406, 3410, 3414, 3502, 3506, 3510, 3514, 3602, 3606, 3610, 3614, 3702, 3706, 3710, 3714, 4202, 4206, 4210, 4214, 4218, and 4222 are being performed by one or more processors are executed by either a single processor or multiple processors. For example, 1602 and 1606 are executed by processor of client device 22, and 1610 and 1614 are executed by processor of client device 18. As another example, processes in 1918 and 1926 are executed by processor of client device 34 and processes in 1928 and 1932 are executed by processor of client device 38.

Moreover, it is noted that 3602, 3606, 3610, 3614, 3702, 3706, 3710, and 3714 are executed in addition to or as an alternative to execution of 2002 and 2006. If 3602, 3606, 3610, 3614, 3702, 3706, 3710, and 3714 are executed as an alternative to execution of 2002 and 2006, RFP server 14 does not provide access to the RFP report to client device 22 managed by a customer and provides access to the RFP summary to the client device 22. It is further noted that all pages, including web pages, and all reports, described herein are stored in the database of RFP server 14 by the server and are accessed by the server by executing the computing module.

It is noted that although FIGS. 3, 4, 9, 10, 16-21, 34-37, and 42 show a consecutive order in which a method for generating and responding to an RFP is executed, in alternative embodiments, the order can change. For example, 422 is performed simultaneously with 426. As another example, 1626 is performed before performing 1622.

Technical effects of the herein described systems and methods for generating an RFP and responding to the RFP include generating, via the computing module stored in a computing system, such as RFP system 10, an RFP, providing, via the computing module, a RFP response to the RFP, and receiving, via the computing module, at least one of a communication related to the RFP and a communication related to the response. Integration of an RFP, an RFP response, and at least one of a communication related to the RFP and a communication related to the response within the computing module links the RFP to the response and to the at least one communication. Accordingly, it is easier for a user with permissions or an administrator to search for a particular communication that is related to an RFP or related to an RFP response. It is also easier for a user with permissions or an administrator to search for an RFP related to a particular communication and a RFP response related to a communication.

Other technical effects include protecting a communication from access and providing an option to a user to remove the protection. Accordingly, a user controls whether a communication is visible to other suppliers or customers and privacy of a communication is protected as long as the user desires. Yet other technical effects include allowing a customer to edit or add a question within an RFP of the custom RFP type to customize the RFP.

Yet other technical effects include determining whether the additional RFP is similar to the initial RFP. The determination of the similarity between the initial and the additional RFPs results in RFP server 14 automatically populating one or more answers within the additional RFP response to reduce manual work of a supplier. The automatic population saves time and effort of a supplier responding to an RFP to which the supplier has responded earlier.

Still other technical effects include ranking questions and sections within an RFP of the custom RFP type. Ranks of questions and sections within an RFP allows an administrator, a supplier, or a customer to view important criteria of the customer quickly. Other technical effects include comparing, by a customer, a plurality of RFP responses from a plurality of suppliers to an RFP, and deciding to buy or lease a product or service based on at least one of the RFP responses.

Yet other technical effects include providing access to an RFP of the default RFP type or an RFP of the custom RFP type to save time of a customer. An access to the RFP of the default RFP type of the custom RFP type saves time and effort of a customer in preparing an RFP. Other technical effects include ranking questions and sections. A customer views an RFP response provided by a supplier in an order of questions or sections from more important to less important.

While the invention has been described in terms of various specific embodiments, those skilled in the art will recognize that the invention can be practiced with modification within the spirit and scope of the claims.

What is claimed is:

1. A method for generating a request for proposal and responding to the request for proposal, said method comprising:
generating, via a computing module stored in a computing system, a request for proposal;
providing, via the computing module, a response to the request for proposal;
receiving at least one of a first communication related to the request for proposal and a second communication related to the response by using the computing module.

2. A method in accordance with claim 1, further comprising protecting the second communication from access by a user other than a customer sending the first communication and a supplier receiving the first communication.

3. A method in accordance with claim 1, further comprising:
protecting the second communication from access by a user other than a customer sending the first communication and a supplier receiving the first communication; and
providing an option to the customer to remove the protection.

4. A method in accordance with claim 1, further comprising protecting the first communication from access by a user other than a supplier sending the second communication and a customer receiving the second communication.

5. A method in accordance with claim 1, further comprising:
protecting the first communication from access by a user other than a supplier sending the second communication and a customer receiving the second communication; and
providing an option to the customer to remove the protection.

6. A method in accordance with claim 1, further comprising compiling a request for proposal summary report based on at least one of the first communication and the second communication and based on at least one of the request for proposal and the response.

7. A method in accordance with claim 1, further comprising:
storing the request for proposal and the response within the computing system; and
retrieving at least one of the request for proposal and the response upon receiving a command from a user.

8. A method in accordance with claim 1, further comprising compiling the request for proposal, the response, and at least one of the first and second communication within a report.

9. A computing system for generating a request for proposal (RFP) and responding to the request for proposal, said computing system comprising:
an RPF memory device configured to store a request for proposal upon executing a computing module;
a response memory device configured to store a response to the request for proposal upon executing the computing module; and
a processor configured to execute the computing module to output the request for proposal and communicate at least one of a first communication related to the request for proposal and a second communication related to the response.

10. A computing system in accordance with claim 9, wherein said processor is configured to protect the second communication from access by a user other than a customer sending the first communication and a supplier receiving the first communication.

11. A computing system in accordance with claim 9, wherein said processor is configured to protect the second communication from access by a user other than a customer sending the first communication and a first supplier receiving the first communication, and wherein said processor is configured to provide an option to the customer to provide access to the second communication to a second supplier other than the first supplier.

12. A computing system in accordance with claim 9, wherein said processor is configured to protect the first communication from access by a user other than a supplier sending the second communication and a customer receiving the second communication.

13. A computing system in accordance with claim 9, wherein said processor is configured to protect the first communication from access by a user other than a first supplier sending the second communication and a customer receiving the second communication, and wherein said processor is configured to provide an option to the customer to provide access to the first communication to a second supplier other than the first supplier.

14. A computing system in accordance with claim 9, wherein said processor is configured to compile a request for proposal summary report based on at least one of the first communication and the second communication and based on at least one of the request for proposal and the response.

15. A web-based system for generating a request for proposal and responding to the request for proposal, said web-based system comprising:
a customer computing device configured to control execution of a computing module to output a request for proposal on a web page; and
a supplier computing device coupled to said customer computing device via a network, said supplier computing device configured to control execution of the computing module to output a response that is based on the request, wherein said computing module is configured to receive at least one of a first communication related to the request for proposal and a second communication related to the response.

16. A web-based system in accordance with claim 15, further comprising a processor configured to execute the computing module, wherein said processor is configured to protect the second communication from access by a user other than a customer sending the first communication and a supplier receiving the first communication.

17. A web-based system in accordance with claim 15, further comprising a processor configured to execute the computing module, wherein said processor is configured to protect the second communication from access by a user other than a customer sending the first communication and a first supplier receiving the first communication, and wherein said processor is configured to provide an option to the customer to provide access to the second communication to a second supplier other than the first supplier.

18. A web-based system in accordance with claim 15, further comprising a processor configured to execute the computing module, wherein said processor is configured to protect the first communication from access by a user other than a supplier sending the second communication and a customer receiving the second communication.

19. A web-based system in accordance with claim 15, further comprising a processor configured to execute the computing module, wherein said processor is configured to protect the first communication from access by a user other than a first supplier sending the second communication and a customer receiving the second communication, and wherein said processor is configured to provide an option to the customer to provide access to the first communication to a second supplier other than the first supplier.

20. A web-based system in accordance with claim 15, further comprising a processor configured to execute the computing module, wherein said processor is configured to compile a request for proposal summary report based on at least one of the first communication and the second communication and based on at least one of the request for proposal and the response.

21. A web-based system in accordance with claim 15, further comprising:
an RFP database configured to store the request for proposal;
a response database configured to store the response; and
a processor configured to access at least one of the request for proposal and the response based on a command from a user.

22. A method for generating a request for proposal and responding to the request for proposal, said method comprising:
receiving an initial request for proposal;
providing an initial response to the initial request for proposal; and
determining, by a processor, whether an additional request for proposal is similar to the initial request for proposal.

23. A method in accordance with claim 22, further comprising populating, by the processor, at least one answer within an additional response to the additional request for proposal with at least one answer within the initial response upon determining that the initial request for proposal is similar to the additional request for proposal.

24. A computing system for generating a request for proposal and responding to the request for proposal, said computing system comprising:
a memory device configured to receive an initial request for proposal;
a memory device configured to store an initial response to the initial request for proposal; and
a processor configured to determine, whether an additional request for proposal is similar to the initial request for proposal.

25. A computing system in accordance with claim 24, wherein said processor configured to populate at least one answer within an additional response to the additional request for proposal with at least one answer within the initial response upon determining that the initial request for proposal is similar to the additional request for proposal.
